(19) United States
(12) Patent Application Publication
(10) Pub. No.: US 2006/0003097 A1
(43) Pub. Date: Jan. 5, 2006

(54) Fabrication of nanoparticle arrays

(76) Inventors: Ronald P. Andres, Lafayette, IN (US); Venugopal Santhanam, Kumbakonam (IN); Rajan Agarwal, Jaipur (IN)

Correspondence Address: MUETING, RAASCH & GEBHARDT, P.A., P.O. BOX 581415, MINNEAPOLIS, MN, 55458, US

(21) Appl. No.: 10/913,258

(22) Filed: Aug. 6, 2004

Related U.S. Application Data
(60) Provisional application No. 60/492,845, filed on Aug. 6, 2003.

(51) Int. Cl. B05D 5/06; B05D 3/02

(52) U.S. Cl. 427/212; 427/372.2; 427/429; 427/256

(57) ABSTRACT

The self-assembly of a close-packed, highly-ordered monolayers of molecularly protected nanoparticles on an assembly surface is disclosed. Also disclosed is the transfer of a nanoparticle monolayer from an assembly surface to a transfer surface. The transfer of a monolayer or multilayer structure of nanoparticles from a transfer surface to a substrate by conformal contact of the transfer surface with the substrate is disclosed. Also disclosed is the removal of protective molecules from nanoparticle cores by exposure to an oxidizing atmosphere (optionally in the presence of UV radiation). The exchange of protective molecules in molecularly protected nanoparticles with other molecules is also disclosed.

### RELATED APPLICATIONS

The present application claims the benefit of U.S. Provisional Patent Application No. 60/492,845, titled FABRICATION OF MONOLAYER AND MULTILAYER NANOPARTICLE ARRAYS ON SOLID SUBSTRATES, filed on Aug. 6, 2003 and of U.S. Provisional Patent Application No. ______, titled SELF-ASSEMBLED THIN-FILMS OF NANOPARTICLES FOR THE FABRICATION OF ELECTRONIC DEVICES, filed on even date herewith (Attorney Docket No. 290.00650161). Both of the above-identified documents are incorporated herein by reference in their respective entireties.

### STATEMENT OF GOVERNMENT RIGHTS

This invention was made with government support under grants from the United States Department of Energy, Grant No. DE-FG02-01ER15207. The U.S. government may have certain rights in this invention.

The present invention relates to the field of nanofabrication. More particularly, the present invention relates to the field of fabrication of thin film structures on substrates in which the films are close-packed arrays of nanoparticles.

The goal of nanotechnology is the creation of useful materials, devices, and systems through the control of matter on the nanometer length scale. One way to accomplish this goal is to synthesize a large number of identical nanoparticles and to fabricate macroscopic assemblies from these nano-scale components. Significant progress has been made in developing synthesis and purification schemes, particularly solution-phase methods, for producing uniform populations of nanoparticles with controllable size, composition, shape, structure and surface chemistry. An important technological challenge that remains is to develop effective ways to assemble these nano-scale components into larger structures and systems. Of particular interest are ordered 2-D and 3-D arrays or crystalline superlattices in which the nanoparticles take the place of the atoms in traditional solids.

### SUMMARY OF THE INVENTION

The present invention provides methods and apparatus for assembling close-packed nanoparticle monolayer arrays, methods and apparatus for transferring the assembled monolayer arrays either to the solid surface of a target substrate or to the transfer surface of a transfer pad to produce structured monolayer and multilayer films and other structures, methods and apparatus for laterally patterning monolayer and multilayer nanoparticle films on a solid substrate, methods and apparatus for removing organic molecules from the nanoparticles in a structured film without significantly disturbing the array structure, and methods and apparatus for exchanging organic molecules on the nanoparticles in a structured film without significantly disturbing the array structure.

As used in connection with the present invention, the term “nanoparticle” refers to solid particles whose size is typically measured in nanometers. For example, it may be preferred that nanoparticles used in connection with the present invention may have a mean diameter of 50 nanometers or less. The variance associated with the mean diameter of a population of nanoparticles used in connection with the invention may preferably be no more than about 50% (more preferably no more than about 10%) of the mean.

Because of their size, it is impractical to assemble macroscopic structures by individual manipulation of such ultra-small particles. The present invention provides methods and apparatus to induce the particles to “self-assemble” into close-packed monolayer arrays that can then be transferred and/or manipulated to produce macroscopic structures.

To facilitate the assembly of nanoparticles into macroscopic close-packed monolayer arrays, it may be preferred to coat nanoparticle cores with an ultrathin layer (preferably a monolayer) of organic molecules. Such encapsulation may preferably prevent the nanoparticle cores from prematurely sintering or bonding to each other and may preferably enable the coated nanoparticles to be suspended as individual particles in a liquid. As used in connection with the present invention, a coated or encapsulated nanoparticle will be referred to as a “molecularly protected nanoparticle” or “MPN”. The organic molecules may preferably be soluble in one or more organic solvents and may, in addition, be relatively insoluble in water or other aqueous solutions.

The macroscopic structures that may be achieved using the methods and apparatus of the present invention include, but are not limited to films, ribbons, patterns, etc. The structures may find use in nano-scale devices such as, e.g., microelectronic devices (as, e.g., interconnects, capacitors, etc.), chemical sensors, biological sensors, catalysis devices, molecular electronic devices, magnetic devices, optical devices (e.g., waveguides, sensors, etc.), etc.

The nanoparticles used in conjunction with present invention may preferably include a core of atoms that form inorganic conductors, dielectrics, and semiconductors. Examples of the atoms that may be used in the nanoparticle cores may be found in the elements from the IIA, IIIA, IVA, VA, VIA, VIIA, IB, IIB, IIIB, and IVB columns of the periodic table, their oxides, nitrides, and sulfides, and IIIB/VB and II/VIB semiconductor compounds. These core particles are typically crystalline or polycrystalline and are often equiaxed with well-defined faceted surfaces. Because of their ultra-small size, the nanoparticles may impart novel mechanical, optical, electrical, and magnetic properties to materials, devices, and systems that are assembled from them. Examples of suitable materials for fabrication of the nanoparticle cores may include, but are not limited to, Au, Ag, Pt, silica, alumina, titania, Fe/Au (see, e.g., International Publication No. WO 03/073444, titled FE/AU NANOPARTICLES AND METHODS (and the corresponding U.S. patent application Ser. No. 10/373,609 filed on Feb. 24, 2003)), etc.

The present invention includes methods and apparatus for fabrication of well-ordered monolayer and multilayer structured films of MPN's on solid substrates and for either: 1) removing the molecules protecting the nanoparticles to produce, e.g., ultrathin structures of uncoated nanoparticles, or 2) replacing the protecting molecules with other molecules that may impart novel mechanical, chemical, biological, electrical, optical or magnetic properties to the arrays. The nanoparticle structured films of the present invention are preferably free of the microscopic defects that characterize films made by other methods and can preferably span macroscopic areas.

The present invention also includes methods and apparatus for laterally patterning these ultrathin nanoparticle structured films so that it may be possible to construct, e.g., lines and patterns of arbitrary complexity on a substrate. The present invention also includes methods and apparatus for vertically patterning multilayer structured films so that adjacent layers may be made of the same or different nanoparticles.

A number of different nanoparticles have been proposed as building blocks for constructing nanoelectronic devices and structures, e.g., metal nanocrystals and nanowires (both magnetic and nonmagnetic), semiconductor nanocrystals and nanowires, and carbon nanotubes. Among these candidates, gold nanocrystals coated with a monolayer of alkanethiol molecules may be particularly interesting due to: 1) the ease by which macroscopic quantities of these MPN's with well-defined chemical and physical properties can be synthesized, 2) the ease by which they can be manipulated in organic solvents and induced to form compact arrays, 3) the ease by which different thiol-terminated molecules can be chemisorbed on the surface of gold nanoparticles, and 4) the inertness of gold to oxidation. Even close-packed arrays of these MPN's, however, have extremely low electrical conductivities due to the insulating character of alkanethiols.

The present invention includes methods and apparatus by which close-packed multilayer films of alkanethiol-protected metallic (e.g., gold) nanoparticles can be transformed by low temperature oxidation into low-resistance conductors and/or can be prepared for facile replacement of the alkanethiol molecules by other organic molecules. Unlike other methods that have been proposed for rendering an amorphous film of metallic MPN's electrically conductive, the methods and apparatus of the present invention preferably do not destroy the well-ordered structure of the film. In particular, the gold nanoparticle arrays retain the ultra-small grain size, the ultra-smooth surface, and the optical transparency of the untreated film.

Low-resistance conductors are important components of high-Q inductors, capacitors, tuned circuits, interconnects, etc. An inexpensive method for fabricating such conductors on a wide variety of substrates may be useful for the development of low-cost microelectronic systems such as, e.g., radiofrequency identification (RFID) tags. The methods and apparatus of the present invention preferably provide an inexpensive method for fabricating small conductive structures on the surfaces of both rigid substrates (e.g., silicon wafers, etc.) and flexible substrates (e.g., polymer films).

Electrical conduction in films of Au MPN's is by electron tunneling between uniform nano-scale metal grains separated by tunnel barriers. Using the methods and apparatus of the present invention it may be possible to adjust these tunnel barriers to change the electrical resistance of such films from highly resistive (ca. 10¹² ohms/sq) to highly conductive (ca. 10 ohms/sq.). By exchanging conjugated organic molecules with the protective molecules used to assemble the nanoparticle arrays, it may be possible to fabricate a nanoparticle structure whose resistance is sensitive to light and/or to the presence of specific chemical agents. In the first case, the nanoparticle structures may be used in photo-detectors. In the second case, these nanoparticle structures may be used in chemical or biological sensors.

The methods and apparatus of the present invention make feasible the integration of nanometer scale particles and components with traditional semiconductor fabrication procedures to produce novel hybrid devices. More particularly, the ability to fabricate patterned, low-cost, ultra-thin, ultra-smooth, conducting structures of nanometer-scale particles and to easily functionalize the surface of these structures with selected organic molecules and/or biological species may find utility in new molecular electronics and/or bio-recognition applications.

Using MPN's synthesized from catalytically active elements (such as, e.g., Pt and other transition metals), the methods and apparatus of the present invention make feasible the fabrication of well-ordered monolayer or multilayer structures of nano-scale catalyst particles on inorganic or polymer substrates (e.g., membranes). The ability to control the size of the catalyst particles, the number per unit area, and the thickness and electrical conductivity of the nanoparticle structure may find utility in the area of, e.g., fuel cell manufacture. The ability to spatially pattern a nanoparticle structure on a solid substrate may find utility in the area of, e.g., catalyzed epitaxial growth of semiconducting nanowires.

Using MPN's synthesized from dielectric or semiconductor nanoparticles, the methods and apparatus of the present invention make it possible to fabricate multilayer nanoparticle structures with novel optical characteristics that may find utility in the manufacture of, e.g., optically active elements and wave guides.

Using magnetic nanoparticles, the methods and apparatus of the present invention make it feasible to fabricate patterned, well-ordered monolayers of magnetic particles that may find utility in, e.g., the manufacture of high density magnetic storage media.

In one aspect, the present invention provides a method of self-assembling a nanoparticle array by providing a body having an orifice formed therein, the orifice having an opening in an upper surface of the body; forming an assembly surface within the orifice, wherein the assembly surface has a gas/aqueous solution interface, wherein the aqueous solution forms a surface having a convex upwards curvature within the orifice; depositing a colloidal suspension on the assembly surface, wherein the colloidal suspension includes hydrophobic nanoparticles suspended in an organic solvent solution, and wherein the colloidal suspension disperses over the assembly surface; and evaporating the organic solvent from the assembly surface, wherein the hydrophobic nanoparticles form a monolayer nanoparticle array on at least a portion of the assembly surface.

In another aspect, the present invention provides a method of transferring a nanoparticle array to a solid surface. The method includes providing a monolayer nanoparticle array within an orifice formed in a body, wherein the orifice has an opening in an upper surface of the body, wherein the nanoparticle array is located on an assembly surface that is located below the upper surface of the body, wherein the assembly surface is a surface formed by an aqueous solution, and wherein the assembly surface has a convex upwards curvature within the orifice; and raising the assembly surface and the monolayer nanoparticle array located thereon towards the upper surface of the body, wherein at least a portion of the monolayer nanoparticle array contacts a solid surface, wherein the portion of the monolayer nanoparticle array in contact with the solid surface remains on the solid surface and forms a nanoparticle array thereon.

In another aspect, the present invention provides a method of forming a multilayer nanoparticle array on a solid surface. The method includes providing a first monolayer nanoparticle array within a first orifice formed in a first body, wherein the first orifice includes an opening in an upper surface of the first body, wherein the first monolayer nanoparticle array is located on a first assembly surface that is located below the upper surface of the first body, wherein the first assembly surface is a surface formed by an aqueous solution, and wherein the first assembly surface has a convex upwards curvature within the first orifice; and raising the first assembly surface and the first monolayer nanoparticle array located thereon towards the upper surface of the first body, wherein at least a portion of the first monolayer nanoparticle array contacts a solid surface, wherein the portion of the first monolayer nanoparticle array in contact with the solid surface remains on the solid surface. The method further includes providing a second monolayer nanoparticle array within a second orifice formed in a second body, wherein the second orifice includes an opening in an upper surface of the second body, wherein the second monolayer nanoparticle array is located on a second assembly surface that is located below the upper surface of the second body, wherein the second assembly surface is a surface formed by an aqueous solution, and wherein the second assembly surface has a convex upwards curvature within the second orifice; and raising the second assembly surface and the second monolayer nanoparticle array located thereon towards the upper surface of the second body, wherein at least a portion of the second monolayer nanoparticle array contacts the first monolayer nanoparticle array on the solid surface. The portion of the second monolayer nanoparticle array in contact with the first monolayer nanoparticle array remains on the first monolayer nanoparticle array after the second assembly surface moves away from the solid surface, wherein the first monolayer nanoparticle array on the solid surface and the second monolayer nanoparticle array attached thereto form a multilayer nanoparticle array on the solid surface. In various embodiments, the first orifice and the second orifice are the same orifice. Also, the nanoparticles in the first and second monolayer nanoparticle array may have the same or different composition.

In another aspect, the present invention provides a method of printing a nanoparticle array on a substrate. The method may include providing a monolayer nanoparticle array within an orifice formed in a body, wherein the orifice includes an opening in an upper surface of the body, wherein the nanoparticle array is located on an assembly surface that is located below the upper surface of the body, wherein the assembly surface is a surface formed by an aqueous solution, and wherein the assembly surface has a convex upwards curvature within the orifice; contacting the monolayer nanoparticle array with a transfer surface, wherein at least a portion of the monolayer nanoparticle array in contact with the transfer surface remains on the transfer surface and forms at least a portion of a nanoparticle array on the transfer surface; contacting a substrate surface with the nanoparticle array on the transfer surface; and removing the transfer surface from proximity to the substrate surface, wherein at least a portion of the nanoparticle array on the transfer surface remains on the substrate surface after removing the transfer surface from proximity to the substrate surface. In various embodiments, the transfer surface may include raised areas and recessed areas located between the raised areas, wherein the monolayer nanoparticle array transfers to at least the raised areas, and further wherein only the raised areas contact the substrate surface, and further wherein only the portions of the monolayer nanoparticle array on the raised areas remain on the substrate surface after removing the transfer surface from proximity to the substrate surface.

In another aspect, the present invention provides a method of providing a nanoparticle array on a substrate. The method includes providing a monolayer nanoparticle array within an orifice formed in a body, wherein the orifice includes an opening in an upper surface of the body, wherein the nanoparticle array is located on an assembly surface that is located below the upper surface of the body, wherein the assembly surface is a surface formed by an aqueous solution, and wherein the assembly surface has a convex upwards curvature within the orifice; contacting the monolayer nanoparticle array with a solid surface including sacrificial material covering portions of the solid surface, wherein at least a portion of the monolayer nanoparticle array in contact with the transfer surface remains on the solid surface and the sacrificial material; removing the sacrificial material from the solid surface, wherein any nanoparticles on the sacrificial material are removed with the sacrificial material such that a patterned nanoparticle array is formed on the solid surface.

In another aspect, the present invention provides a method of removing a coating from nanoparticles in a structured nanoparticle array by providing a substrate having a structured nanoparticle array located on a surface of the substrate, wherein each of the nanoparticles is coated with organic molecules; and removing at least some of the organic molecules from at least some of the nanoparticles by exposing the nanoparticles to an oxidizing gas.

In another aspect, the present invention provides a method of modifying a nanoparticle array on a substrate. The method includes providing a solid substrate having at least one structured nanoparticle array located on a surface of the substrate, wherein each of the nanoparticles is coated with organic molecules; and contacting the at least one structured nanoparticle array with replacement molecules while contacting the at least one structured nanoparticle array with an exchange surface, wherein at least some of the replacement molecules exchange with at least some of the organic molecules coating the nanoparticles; and removing the exchange surface from the at least one structured nanoparticle array, wherein at least some of the nanoparticles retain exchanged replacement molecules after removal of the exchange surface.

In another aspect, the present invention provides a method of providing a nanoparticle array on a surface. The method includes providing a body with an orifice formed therein, the orifice having an opening in an upper surface of the body and forming an assembly surface using an aqueous solution within the orifice, wherein the assembly surface forms a gas/aqueous solution interface, wherein the assembly surface has a convex upwards curvature within the orifice. The method further includes depositing a colloidal suspension on the assembly surface, wherein the colloidal suspension includes hydrophobic nanoparticles suspended in an organic solvent solution, and wherein the colloidal suspension disperses over the assembly surface; and evaporating the organic solvent from the assembly surface, wherein the hydrophobic nanoparticles form a monolayer nanoparticle array on at least a portion of the assembly surface. The method further includes contacting the monolayer nanoparticle array with a transfer surface, wherein at least a portion of the monolayer nanoparticle array in contact with the transfer surface remains on the transfer surface and forms at least one layer of a nanoparticle array on the transfer surface; contacting a solid substrate surface with the nanoparticle array on the transfer surface; removing the transfer surface from proximity to the substrate surface, wherein at least a portion of the nanoparticle array on the transfer surface remains on the substrate surface after removing the transfer surface from proximity to the substrate surface. The method further includes removing at least some organic molecules from at least some of the hydrophobic nanoparticles in the nanoparticle array on the substrate surface by exposing the hydrophobic nanoparticles to an oxidizing gas; contacting the nanoparticles in the nanoparticle array on the substrate surface with replacement molecules while contacting the nanoparticle array with an exchange surface, wherein at least some of the replacement molecules exchange with at least some of the organic molecules remaining on the nanoparticles after exposing the hydrophobic nanoparticles to an oxidizing gas; and removing the exchange surface from the nanoparticle array, wherein at least some of the nanoparticles retain exchanged replacement molecules after removal of the exchange surface.

In another aspect, the present invention provides a method of providing a nanoparticle array on a surface. The method includes providing a body with an orifice formed therein, the orifice including an opening in an upper surface of the body; forming an assembly surface using an aqueous solution within the orifice, wherein the assembly surface forms a gas/aqueous solution interface, wherein the assembly surface has a convex upwards curvature within the orifice; and depositing a colloidal suspension on the assembly surface, wherein the colloidal suspension includes hydrophobic nanoparticles suspended in an organic solvent solution, and wherein the colloidal suspension disperses over the assembly surface. The method further includes evaporating the organic solvent from the assembly surface, wherein the hydrophobic nanoparticles form a monolayer nanoparticle array on at least a portion of the assembly surface; and contacting the monolayer nanoparticle array with a solid surface, wherein at least a portion of the monolayer nanoparticle array in contact with the solid surface remains on the solid surface and forms at least one layer of a nanoparticle array thereon. The method further includes removing at least some organic molecules from at least some of the hydrophobic nanoparticles in the nanoparticle array on the solid surface by exposing the hydrophobic nanoparticles to an oxidizing gas; contacting the nanoparticle array on the solid surface with replacement molecules while contacting the nanoparticle array with an exchange surface, wherein at least some of the replacement molecules exchange with at least some of the organic molecules remaining on the nanoparticles after exposing the hydrophobic nanoparticles to an oxidizing gas atmosphere; and removing the exchange surface from the nanoparticle array, wherein at least some of the nanoparticles retain exchanged replacement molecules after removal of the exchange surface.

These and other features and advantages of the present invention may be described below in connection with some exemplary embodiments of the methods and apparatus of the present invention.

### BRIEF DESCRIPTIONS OF THE FIGURES

FIG. 1 depicts one cell that may be used for self-assembly of molecularly protected nanoparticles in accordance with the present invention.

FIG. 2 depicts the cell of FIG. 1 with a colloidal suspension located on an assembly surface within the orifice.

FIG. 3 depicts the cell of FIG. 2 during evaporation of the solvent in the colloidal suspension.

FIG. 4 depicts a stepped orifice that may be used for self-assembly of monolayer MPN arrays in connection with the present invention.

FIG. 5 depicts the stepped orifice of FIG. 4 after complete evaporation of the solvent used in the colloidal suspension of MPN's.

FIG. 6-8 depict one transfer process for transferring a monolayer MPN array to a transfer surface in accordance with the present invention.

FIG. 9 is a transmission electron microscope (TEM) micrograph of a close-packed monolayer of 5 nm diameter, dodecanethiol-coated, Au nanoparticles on a carbon membrane TEM grid.

FIG. 10 is a TEM micrograph of a close-packed bilayer of 5 nm diameter, dodecanethiol-coated, Au particles on a carbon membrane TEM grid. The three inserts in FIG. 10 are Fourier transforms of the regions enclosed in the indicated squares. FIGS. 11 & 12 depict one method of printing a laterally patterned nanoparticle array using a structured transfer surface.

FIGS. 13A-13C depict a method of providing patterned arrays of close-packed MPN's directly on the solid surface of a target substrate.

FIG. 14 is a schematic diagram of one apparatus for exchanging protective molecules on MPN's in a structured film with replacement molecules.

FIG. 15 depicts FTIR spectra for a monolayer array of Au MPN's before and after exchange of dodecanethiol molecules with replacement xylyl dithiol molecules.

FIG. 16 depicts FTIR spectra for a 4-layer nanoparticle array structure of 10 nm Au MPN's before and after exchange of dodecanethiol molecules with replacement xylyl dithiol molecules.

FIG. 17 depicts FTIR spectra for a bilayer nanoparticle array structure of 10 nm Au MPN's before and after exchange of dodecanethiol molecules with replacement xylyl dithiol molecules.

FIG. 18 is a schematic diagram of another apparatus for exchanging protective molecules on MPN's in a structured film with replacement molecules.

FIG. 19 is an optical micrograph depicting vacuum deposited gold contacts on a substrate.

FIG. 20 depicts FTIR spectra for a bilayer nanoparticle array structure of 10 nm Au MPN's before and after oxidation of the protective dodecanethiol molecules.

FIG. 21 depicts XPS spectra for a 4-layer nanoparticle array structure of 10 nm Au MPN's before and after oxidation of the protective dodecanethiol molecules.

FIG. 22 is a TEM micrograph of a close-packed 4-layer structure of 10 nm diameter, dodecanethiol-coated, Au particles before oxidation.

FIG. 23 is a TEM micrograph of the close-packed 4-layer structure of 10 nm diameter, dodecanethiol-coated, Au particles of FIG. 22 after oxidation.

FIG. 24 is a plot depicting temperature dependence of electrical conductivity for a 6-layer structure of 10 nm diameter, dodecanethiol-coated, Au particles after oxidation.

### DETAILED DESCRIPTION OF EXEMPLARY EMBODIMENTS OF THE INVENTION

In the following detailed description of some exemplary embodiments of the invention, reference is made to the accompanying figures which form a part hereof, and in which are shown, by way of illustration, specific embodiments in which the invention may be practiced. It is to be understood that other embodiments may be utilized and structural changes may be made without departing from the scope of the present invention.

The present invention includes five aspects that may be used alone or together: 1) the self-assembly of a close-packed, preferably highly-ordered, monolayer of MPN's on an assembly surface, 2) the transfer of this nanoparticle monolayer from the assembly surface to a transfer surface, which may be the surface of a target substrate or the surface of a separate elastomeric transfer pad (that may preferably be constructed of, e.g., polydimethylsiloxane (PDMS)), by conformal contact of the transfer surface and the nanoparticle monolayer (multiple monolayers may be transferred to the transfer surface when a multilayer array is desired), 3) the transfer of a MPN monolayer or multilayer from the transfer surface of an elastomeric transfer pad to a target solid substrate by conformal contact of the pad with the substrate, 4) the removal of the molecules protecting the cores of the MPN's in a monolayer or multilayer structured naoparticle film by, e.g., exposing the film to an oxidizing gas atmosphere, and 5) exchange of the protecting molecules with other molecules by immersing the film (that may be preferably covered by an elastomeric pad) in a solution of the exchange molecules in a suitable solvent. Exemplary embodiments of each of these different aspects are described below.

Further, discussions of some or all of these different aspects of the invention may be described in one or more of the following documents: “Metal Nanoparticles and Their Self-Assembly into Electronic Nanostructures,” Venugopal Santhanam and Ronald P. Andres, Dekker Encyclopedia of Nanoscience and Nanotechnology, pp. 1829-1840 (2004); “Microcontact Printing of Uniform Nanoparticle Arrays,” Venugopal Santhanam and Ronald P. Andres, Nano Letters 4, 41-44, 2004 and/or “Self-Assembly of Uniform Monolayer Arrays of Nanoparticles,” Venugopal Santhanam, Jia Liu, Rajan Agarwal, and Ronald P. Andres, Langmuir 19, 7881-7887, 2003.

Before discussing the above aspects, however, a brief discussion of some characteristics of suitable molecularly protected nanoparticles may be in order. As discussed herein, the MPN's are preferably formed with a core that is protected by a thin coating, preferably a monolayer of protective molecules. A variety of potentially suitable materials for the cores of the MPN's are described above.

The protective molecules may preferably exhibit a number of different characteristics. At a basic level, it may be preferred that the protective molecules be hydrophobic and/or cause the entire MPN to exhibit hydrophobicity. It may further be preferred that the protective molecules contain an end group that preferentially adsorbs on the surface of the core of the MPN and a relatively long organic tail that provides solubility for the MPN in non-polar organic solvents. For example, molecules that combine an alkyl chain or chains with a thiol, a disulfide, an amine or a carboxylic head group may be suitable protective molecules. It may be preferred that the protective molecules are not water soluble. One potentially suitable set of protective molecules are linear alkanethiols, e.g., dodecanethiol. Other potentially suitable protective molecules may include molecules that combine an end group containing a disulfide (e.g., lipoic acid) and an alkyl chain. Another set of potentially suitable protective molecules may include resorcinarenes that have multiple alkyl groups and thiol groups. Such molecules and methods of coating nanoparticles with the same may be found in K. B. Stavens, S. V. Pusztay, S. Zou, R. P. Andres, A. Wei, “Encapsulation of Neutral Gold Nanoclusters by Resorcinarenes,” Langmuir 15, 8337 (1999). Other potentially useful protective molecules may be described in International Publication No. WO 03/073444, titled FE/AU NANOPARTICLES AND METHODS (and the corresponding U.S. patent application Ser. No. 10/373,609 filed on Feb. 24, 2003).

Self-Assembly of Close-Packed MPN Monolayers

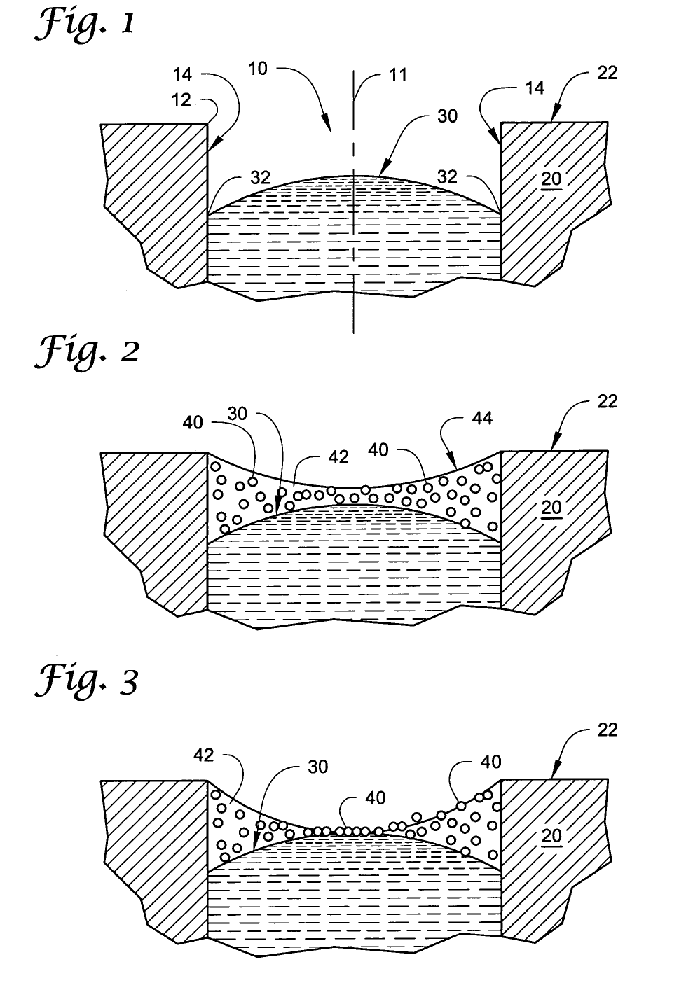

The present invention provides methods and apparatus for self-assembling a close-packed well-ordered monolayer array of MPN's on an assembly surface. One apparatus useful in connection with self-assembling monolayers of MPN's is depicted in FIG. 1 in which an orifice 10 is formed within a body 20. The orifice 10 includes an opening 12 in the upper surface 22 of the body 20. The orifice 10 includes one or more sides 14. The orifice 10 may preferably have a circular shape when viewed along axis 11, although orifices having other shapes may be used in some instances.

An assembly surface 30 is preferably formed within the orifice below the upper surface 22 of the body 20. The assembly surface 30 is the upper surface of an aqueous solution located within the orifice 10. In one exemplary embodiment, the aqueous solution forming the assembly surface 30 consists essentially of water and the atmosphere above the assembly surface is air, making the assembly surface 30 in such an embodiment an air/water interface. The assembly surface 30 forms an edge 32 about the perimeter of the orifice 10. In some instances, the aqueous solution may include materials in addition to water as discussed herein. Furthermore, the atmosphere above the assembly surface may be a gas or gases other than air, e.g., nitrogen, etc. As a result, in a broader sense, the assembly surface 30 preferably forms a gas/aqueous solution interface within the orifice 10.

It may be preferred that the assembly surface 30 have a convex upwards curvature within the orifice 10 such that the center of the assembly surface is higher (i.e., closer) to the upper surface 22 of the body 20 than the edge 32 of the assembly surface 30. To adjust the vertical position of the assembly surface 30 or to cause the assembly surface 30 to take the desired convex shape, it may be preferred to fill the orifice 10 from the bottom (i.e., not through the opening 12).

Another factor that may assist in causing the assembly surface 30 to take a convex shape with upward curvature is to provide the sides 14 of the orifice 10 of a material that is hydrophobic. As used in connection with the present invention, a material is hydrophobic if it exhibits a static contact angle with pure water of 90 degrees or more. One suitable hydrophobic material for the sides 14 of the orifice 10 is polytetrafluoroethylene (PTFE—available under the tradename TEFLON).

Use of the apparatus depicted in FIG. 1, preferably includes depositing a colloidal suspension of MPN's on the assembly surface 30 such that the assembly surface 30 is covered is covered by the colloidal suspension. FIG. 2 depicts the assembly surface 30 after a colloidal suspension has been deposited thereon. The colloidal suspension includes molecularly protected nanoparticles 40 in an organic solvent 42. The organic solvent 42 carrying the MPN's 40 preferably forms a concave surface 44 with downward curvature as seen in FIG. 2. It may be preferred that the organic solvent solution 42 be capable of wetting the sides 14 of the orifice 10, i.e., that it form a relatively small contact angle with the sides 14 of the orifice 10. If the organic solvent solution 42 forms a concave surface 44 with downward curvature and the assembly surface 30 forms an convex shape with an upward curvature as seen in FIG. 2, the colloidal suspension will take on a general lens shape as seen in FIG. 2.

The organic solvent 42 in which the MPN's are suspended may preferably have a variety of characteristics. It may be preferred that the organic solvent be capable of dispersing the MPN's as individual particles, that it is immiscible with the aqueous solution forming the assembly surface 30, that it spreads on the assembly surface 30 of the aqueous solution, that it has a density less than the density of the aqueous solution forming the assembly surface 30, and that it has a higher volatility than the aqueous solution forming the assembly surface 30.

As discussed herein, it may be preferred that the organic solvent solution be a blend of one or more organic solvents, although in some instances the organic solvent solution may contain only one organic solvent. It may be preferred that the organic solvent solution contain non-polar organic solvents. It may also be preferred that the density of the organic solvent solution 42 decrease as the solution evaporates from the assembly surface 30. Although not wishing to be bound by theory, it is theorized that when the density of the organic solvent solution 42 decreases during evaporation, the MPN's may be more likely to form a close-packed monolayer array on the assembly surface 30.

FIG. 3 depicts the apparatus after some evaporation of the organic solvent solution 42. As the solvent evaporates, a preferably circular raft of close-packed MPN's 40 forms where the solvent solution 42 is thinnest which will typically be at the center of the orifice 10. A contact line forms at the edge of this floating island of MPN's 40. As the solvent 42 continues to evaporate, the MPN's 40 preferably move towards the center of the orifice 10 and the floating island of MPN's continues to grow. After the solvent 42 has completely evaporated, the assembly surface 30 may preferably be covered by the MPN's 40.

In some instances, the MPN's 40 may not form a monolayer across the entire assembly surface 30 within the orifice 10. Rings or areas of multilayer arrays of the MPN's 40 may form proximate the sides 14 of the orifice 10. Proper selection of the concentration of MPN's 40 in the colloidal suspension and the amount of the colloidal suspension deposited on the assembly surface 30 can, however, enlarge the area occupied by the preferred close-packed monolayer array of MPN's 40. Specific concentrations of MPN's 40 within the colloidal suspension and the amount of the colloidal suspension used may vary based on a variety of factors such as the size and/or composition of the MPN's 40, the organic solvent solution 42 used, the aqueous solution forming the assembly surface 30, the size and/or shape of the orifice 10, etc. Some potential concentrations are described in connection with the examples described herein.

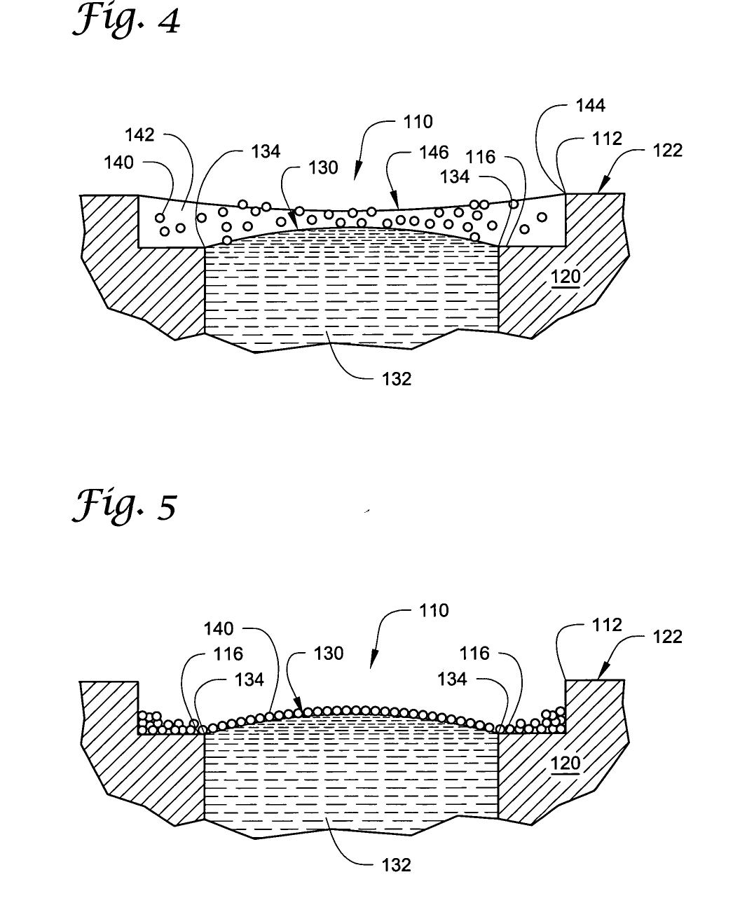

FIGS. 4 & 5 depict an alternative self-assembly apparatus with a body 120 including an orifice 110 in which an assembly surface 130 is located. The orifice 110 also includes a step 116 below the opening 112 in the upper surface 122 of the body 120 in which the orifice 110 is located. The orifice 110 widens at the step 116 as seen in, e.g., FIG. 4 such that the opening 112 is wider than the orifice 110 below the step 116. It may be preferred that the step 116 be formed as a discontinuous feature, e.g., at a right angle as seen in FIGS. 4 & 5.

It is preferred that the edges 134 of the assembly surface 130 formed by the aqueous solution 132 be located below the step 116, i.e., such that the step 116 is located between the edges 134 and the opening 112 of the orifice 110. With the colloidal suspension including MPN's 140 in an organic solvent solution 142 deposited on the assembly surface 130, the edges 134 preferably remain at the level of the step 116 or below the step 116. It may be preferred that the level of the aqueous solution 132 be such that the edges 134 of the assembly surface 130 are located below the step when the colloidal suspension is deposited on the assembly surface 130.

After the colloidal suspension is in place on the assembly surface 130, the level of the aqueous solution 132 may preferably be raised such that the edges 134 of the assembly surface are at or proximate the step 116. The edges 144 of the surface 146 of the colloidal suspension (also referred to as the gas/colloidal suspension interface) are preferably located above the step 116 as seen in, e.g., FIG. 4. When deposited, however, the edges 144 of the colloidal suspension may be located below the step 116, with the edges 144 of the colloidal suspension being raised above the step 116 after the colloidal suspension has been deposited on the assembly surface 130. Raising of the edges 144 of the colloidal suspension may preferably be accomplished by raising the assembly surface 130 to a position closer to the step 116 after depositing the colloidal suspension on the assembly surface 130.

As discussed above with respect to FIG. 2, it may be preferred that the colloidal suspension take a generally lens shape wherein the upper exposed surface 146 of the colloidal suspension is concave with a downward curvature (such that the edges 144 are higher than the central portion of the colloidal suspension).

The widening of the orifice 110 above the step 116 may cause the downward curvature of the upper surface 146 to be less pronounced, i.e., the upper surface 146 is flatter than it would be if the orifice 110 had a constant cross-sectional area between the edges 134 of the assembly surface 130 and the opening 112 of the orifice 110 (as in FIGS. 1-3). In addition, the thickness of the colloidal suspension may be thinner.

Another potential advantage of the stepped orifice 110 is that the MPN's 140 may preferably form a close-packed monolayer array over the entire assembly surface 130 as depicted in FIG. 5. Additional MPN's 140 may be left on the step 116 depending on the amount of the colloidal suspension deposited on the assembly surface 130. Yet another potential advantage of the stepped orifice 110 is that the self-assembly process may proceed faster than self assembly in an orifice with a constant cross-sectional area from the assembly surface of the aqueous solution up to the opening of the orifice.

With a close-packed monolayer array of molecularly protected nanoparticles positioned on the assembly surfaces of the cells depicted in FIGS. 3 and 5, the aspects of the invention related to transfer of these arrays to other selected surfaces can now be discussed.

Some exemplary dimensions for a stepped orifice that may be useful in connection with the present invention may include a circular orifice with a diameter of 1.25 inches (32 millimeters) with the orifice widening at the step to a diameter of 1.625 inches (41 millimeters). The step may preferably be located 0.12 inches (3 millimeters) below the upper surface of the body, while the orifice extends 0.08 inches (2 millimeters) below the step before widening into a larger reservoir for the aqueous solution.

Transfer of a Nanoparticle Monolayer Array

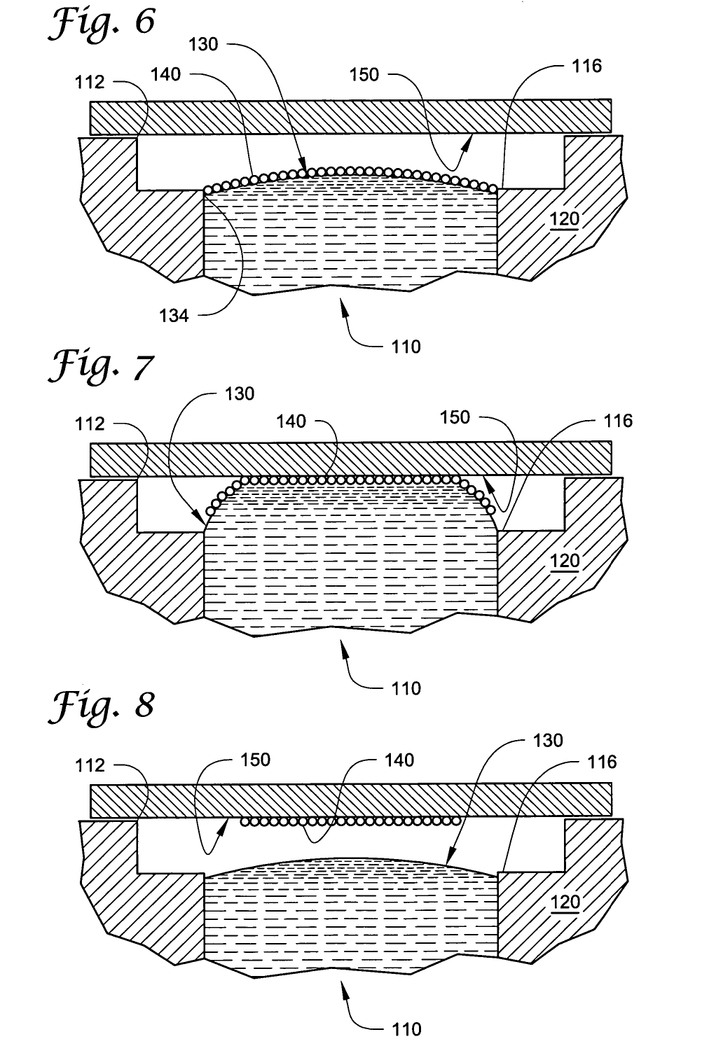

The transfer of a monolayer array of MPN's is preferably accomplished while maintaining the close-spaced, well-ordered arrangement of the array. One exemplary method of accomplishing transfer of a nanoparticle array from the assembly surface to transfer surface is described in connection with FIGS. 6-8.

As seen in FIG. 6, the array of MPN's 140 is located on assembly surface 130 within orifice 110 (although stepped orifice 110 is depicted in connection with this transfer process, it should be understood that a constant dimension orifice such as orifice 10 could alternatively be used in the transfer process). The transfer surface 150 is preferably positioned above the array of MPN's 140, e.g., as depicted in FIG. 6. The level of the assembly surface 130 is then preferably raised within the orifice 10. The assembly surface (and array of MPN's 140) may be raised by increasing the volume of the aqueous solution within the orifice 110. That volume increase may be accomplished by adding more aqueous solution to the cell (preferably not directly into the orifice 110 through opening 112) or by any other suitable technique (e.g., use of a piston below the aqueous solution in the orifice 110, etc.) By gently raising the level of the assembly surface 130, the integrity of the monolayer array located thereon is preferably maintained.

Eventually, the array of MPN's 140 eventually contacts the transfer surface 150 as depicted in FIG. 7. Continued increases in the level of the assembly surface 130 increase the contact area of the MPN array with the transfer surface 150. It may be preferred that for a stepped orifice 110, the edges 134 of the assembly surface 130 remain at or below the step 116. Raising the assembly surface edges 134 above the step may cause disruptions in the array of MPN's 140.

At some point, elevation of the assembly surface 130 towards that transfer surface 150 is discontinued and the assembly surface 130 is lowered, preferably leaving the array of MPN's 140 on the transfer surface 150. It may be preferred to provide for a dwell time when the assembly surface 130 reaches its peak elevation within the orifice 110 to assist in transfer of the array to the transfer surface.

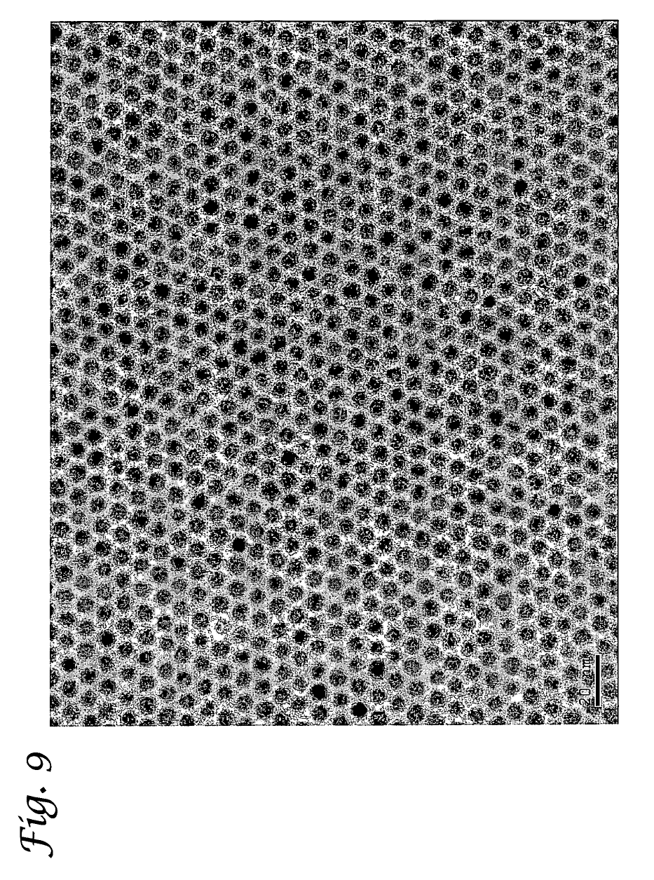

After the assembly surface 130 is lowered as depicted in FIG. 8, the transfer surface 150 can be removed from the opening 112 with a close-packed monolayer array of MPN's 140 located thereon. Ideally, a close-packed monolayer of MPN's 140 would be a perfect hexagonal superlattice with center-to-center particle spacing equal to the diameter of the nanoparticle cores plus twice the thickness of the layer of organic molecules encapsulating the cores. In practice, however, self-assembled monolayers of MPN's only approach this ideal. Although they are typically continuous and close-packed, they may include point defects and dislocations that are observable by transmission electron microscopy. A transmission electron micrograph of a good quality monolayer of 5 nm diameter Au dodecanethiol-coated MPN's produced by the methods and apparatus of the present invention is shown in FIG. 9.

Other potentially suitable methods of transferring the MPN array to a transfer surface may include, e.g., contacting the self-assembled MPN array on the assembly surface with a transfer surface while maintaining the location of the assembly surface constant within the orifice. Removal of the transfer surface from proximity to the assembly surface will typically result in transfer of the self-assembled MPN array to the transfer surface. Some exemplary embodiments of such methods in which a laterally patterned elastomeric stamp pad was used as the transfer surface and nanoparticle films were printed on various solid substrates by subsequent conformal contact between the elastomeric stamp pad and the target substrate may be described in more detail in “Microcontact Printing of Uniform Nanoparticle Arrays,” Venugopal Santhanam and Ronald P. Andres, Nano Letters 4, 41-44, 2004.

When a multilayer nanoparticle structure is desired, individual nanoparticle monolayer arrays may preferably be separately self-assembled on the assembly surface of a cell and then individually transferred to build up a multilayer structure of two or more individual monolayer arrays. Although the first layer array is transferred directly to the transfer surface, subsequent arrays are transferred to an already transferred array attached to the transfer surface. When a new MPN monolayer array is transferred to a substrate on which an existing monolayer MPN array is already located, the average center-to-center spacing of the particles in each layer may preferably remain unaltered. However, the particles in the monolayer array being added may preferably adjust their local order to decrease the vertical height of the multilayer structure. As a result, multilayer films produced by the methods and apparatus of the present invention, while close-packed, may be characterized by numerous small local dislocations. For example, the average layer spacing in a multilayer film is the distance between (111) planes in a perfect FCC lattice, i.e. 0.816 times the average center-to-center spacing between particles in a given layer of the multilayer structure, but locally this spacing may vary about the average.

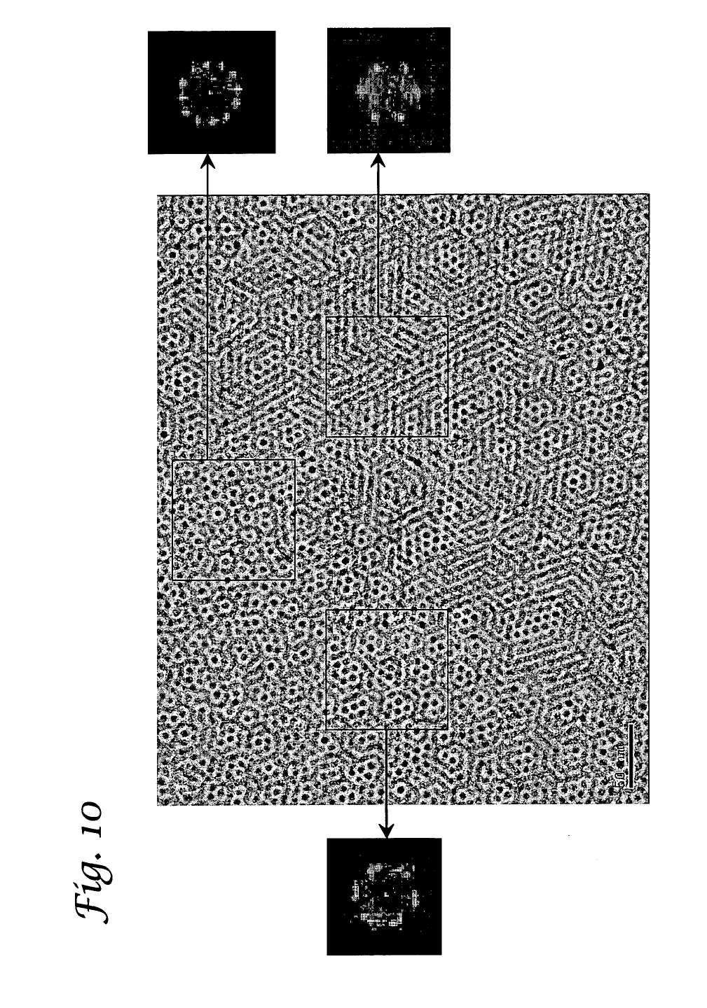

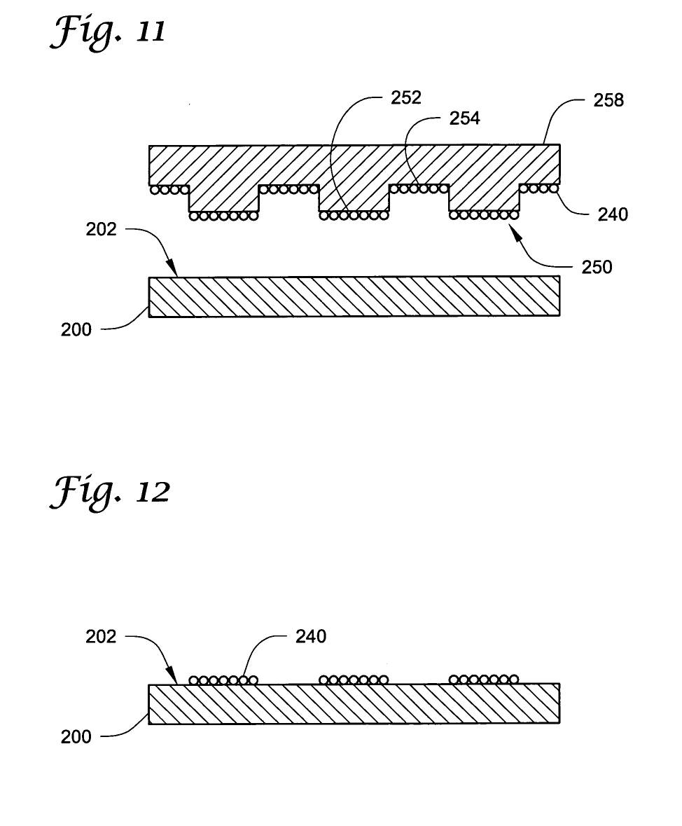

A transmission electron micrograph of a bilayer of MPN's with a 5 nm diameter Au core coated with dodecanethiol that illustrates the various local structures that may be produced by the methods and apparatus of the present invention is shown in FIG. 10. The bilayer film was fabricated by sequential transfer of two self-assembled monolayers onto a carbon membrane TEM grid. The three inserts in FIG. 10 are Fourier transforms of the regions enclosed in the indicated squares. They illustrate various lattice structures that may be found in close-packed bilayer films. Each of the transforms indicate that both upper and bottom layers of the bilayer structure are hexagonal close-packed monolayers with the same lateral particle spacing. The upper insert on the right shows an area of the film in which the two hexagonal monolayers are rotated 30 degrees (about a normal axis) with respect to each other. The lower insert on the right shows an area of the film in which the two monolayers are translated with respect to each other as they might be in a FCC or HCP crystal. The insert on the left shows an area of the film in which the two monolayers are rotated 15 degrees (about a normal axis) with respect to each other.

Multilayer structures of MPN arrays may be fragile if, e.g., the particles are coated with organic molecules that are liquid at room temperature. Thus, it may be preferred to strengthen an array of MPN's after it has been self-assembled to make it more robust. Two methods have been discovered for strengthening arrays of MPN's with gold cores coated with dodecanethiol molecules and it is expected that similar methods may be devised for other MPN's.

The first method is to increase the strength of the interaction between the MPN's in the array and the substrate. Due to the importance of silicon in microelectronics, it may be useful for many applications of nanoparticle films that they adhere to SiO₂ surfaces. Exposing a SiO₂ surface to hexamethyldisilazane (HDMS) vapor in, e.g., a Bell Jar, for a few minutes may make the SiO₂ surface hydrophobic. As a result, the Au nanoparticles coated with dodecanethiol molecules attach more robustly to the substrate.

A second method for strengthening multilayer structures of Au MPN arrays is to add a small concentration of pyridinethiol (PySH) (e.g., 10-20 mM) in the deionized water used to form the assembly surface in the self-assembly cell. It may be preferred that the PySH be charged in the aqueous solution (causing it to exhibit a yellow color). This addition of PySH has been found to increase the robustness of dodecanethiol-coated Au nanoparticle arrays without altering the structure of the array. Without wishing to be bound by theory, it is hypothesized that because dodecanethiol is quite insoluble in water, the PySH molecules attach at defect sites within the array rather than replacing the dodecanethiol molecules on the nanoparticles. As support for this theory, XPS measurements indicate that PySH bonds to the Au particles via the sulfur atom rather than via the nitrogen atom.

In any multilayer nanoparticle array structure, the opportunity may exist for providing different MPN's in the different layers. The ability to do so may be predicated on compatibility of the different MPN's in the different layers both chemically and physically (e.g., compatible size and particle-to-particle spacing).

Although the transfer surface to which the self-assembled MPN arrays are transferred (from the assembly surface) may itself be the target substrate on which the MPN arrays are to remain, in many instances, the transfer surface may merely provide a vehicle that can be used to move the self-assembled monolayer MPN arrays (single layers or multilayers) to a target substrate surface. Some methods of printing of MPN arrays onto a target substrate may be described below.

Printing MPN Arrays

Some exemplary methods and apparatus for printing a MPN array on a substrate may be described in “Microcontact Printing of Uniform Nanoparticle Arrays,” Venugopal Santhanam and Ronald P. Andres, Nano Letters 4, 41-44, 2004. Because it is preferred to retain the close-packed and well-ordered nature of the self-assembled MPN arrays, care should be taken in the selection of a suitable transfer surface. Typically, the transfer surfaces used in connection with printing MPN arrays are preferably relatively free of surface defects or inconsistencies because such features may disturb the close-packed, well-ordered nature of the arrays.

It may be preferred that the materials used for the transfer surface be elastomeric, i.e., exhibit some degree of flexibility as opposed to being rigid surfaces. Suitable materials for the transfer surface may include, e.g., polydimethylsiloxane (PDMS). The materials used for the transfer surface may also preferably be relatively insoluble in water and organic solvents that may be used in connection with the MPN arrays as described herein. Another potentially useful feature is that the materials of the transfer surface may preferably exhibit some porosity such that organic molecules (such as, e.g., those found in organic solvents) can diffuse through the pores in the transfer surface while the larger nanoparticle cores (such as, e.g., Au) cannot diffuse into the transfer surface.

In some instances, it may be preferred to print selected patterns such as lines, pads, etc. using the close-packed MPN arrays self-assembled on the assembly surfaces. One approach to providing such patterns may include the use of a structured transfer surface that essentially acts as a stamp pad, with raised features corresponding to the selected pattern to be printed using the transfer surface. It may be preferred that such structured transfer surfaces be manufactured of elastomeric materials as discussed herein (e.g., PDMS). Some potentially suitable methods of creating structured transfer surfaces (stamp pads) of PDMS may be described in, e.g., “Microcontact Printing of Uniform Nanoparticle Arrays,” Venugopal Santhanam and Ronald P. Andres, Nano Letters 4, 41-44, 2004 and/or “Self-Assembly of Uniform Monolayer Arrays of Nanoparticles,” Venugopal Santhanam, Jia Liu, Rajan Agarwal, and Ronald P. Andres, Langmuir 19, 7881-7887, 2003. Briefly, however, a patterned stamp is first produced by submerging a silicon substrate containing a lithographically defined resist pattern in unlinked polymer. The polymer is cross-linked and peeled from the silicon substrate mold to yield an elastomeric pad whose surface is a mirror image of the resist pattern. Other methods and/or materials for making structured transfer surfaces may be substituted for those specifically described herein and in the documents identified herein.

After the structured transfer surface has been fabricated, the actual printing may preferably be a two-step process. First, one or several nanoparticle monolayers are transferred from the self-assembly cell to the structured transfer surface using the methods described herein. After the one or more close-packed MPN arrays are located on the transfer surface, the transfer surface and the substrate to which the MPN's are to be transferred are contacted with each other. By providing an elastomeric transfer surface, conformal contact between the arrays and the substrate may be more likely and may lead to more accurate transfer of the MPN arrays to the substrate surface.

One example of such a process is depicted in FIGS. 11 & 12. A pad 258 may preferably be provided that includes a transfer surface 250 with raised features 252 and recessed areas 254 located between the raised features 252. A close-packed array of MPN's 240 is preferably located on the transfer surface 250. At a minimum it is preferred that the MPN's be found on the raised features 252, although in many instances the MPN's will also be located on the recessed areas 254 as well.

A substrate 200 is then located proximate the transfer surface 250 and contact is initiated between the transfer surface 250 and the surface 202 of the substrate 200 that faces the transfer surface 250. It may be preferred that light pressure be applied to assist in the transfer of the MPN's to the surface 202 of the substrate 200. It may be preferred that the contact and pressure be maintained for a dwell time to assist in the printing process.

The transfer surface 250 of the pad 258 is then removed from proximity with the substrate surface 202, but preferably leaves MPN's 240 on the surface 202 in a pattern that substantially matches the raised features 252 on the transfer surface 250. It may be preferred that the MPN's 240 on the transfer surface 250 that are not located on the raised features 252 are not transferred to the substrate surface 202.

Several examples of patterned arrays of Au nanoparticles printed on Si and Si₃N₄ substrates are described in the publications identified herein. In addition to rigid substrates, patterned multilayer arrays of Au MPN's have also been printed on flexible film substrates, e.g., polyethylene film.

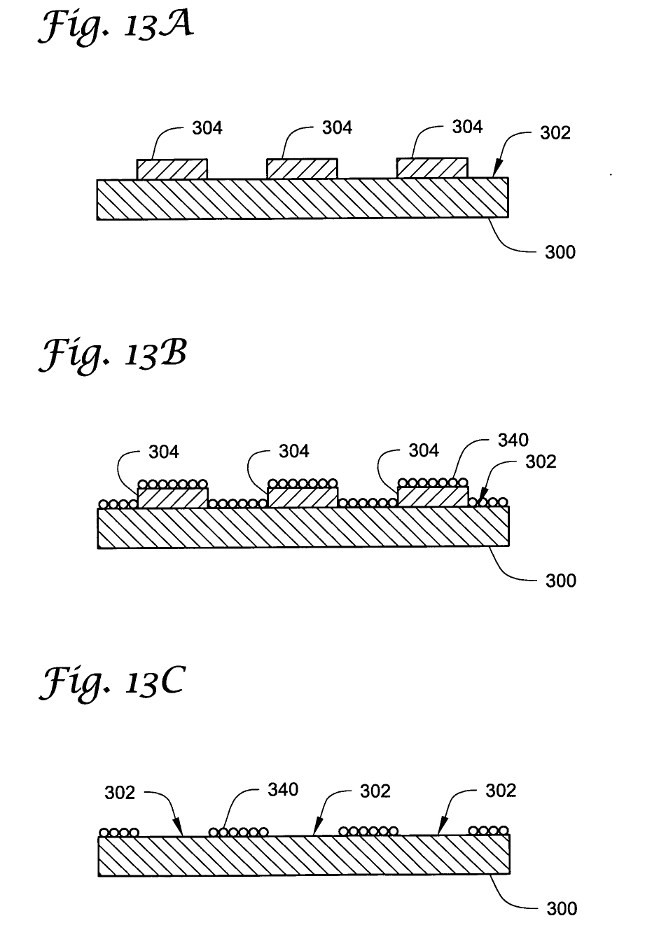

An alternative method of forming patterned arrays of close-packed MPN's (mono or multilayer) directly on the solid surface of a target substrate is depicted in FIGS. 13A-13C. The target substrate 300 includes a solid surface 302. A sacrificial material 304 such as, e.g., photoresist, is located on at least a portion of the surface 302 in selected areas. The substrate 300 may preferably be, e.g., a silicon wafer or other substrate used in the construction of electronic devices.

One or more layers of close-packed arrays of MPN's 340 are transferred to the surface 302 with the sacrificial material 304 located thereon using the methods described above in connection with FIGS. 6-8 (e.g., by placing the substrate 300 over the orifice in which a self-assembled array of MPN's is formed on an assembly surface).

The result of the transfer process is that one or more layers of close-packed arrays of MPN's 340 are located on both the sacrificial material 304 and the portions of surface 302 of the substrate 300 that are not covered by the sacrificial material 304 (as seen in FIG. 13B).

Removal of the sacrificial material 304 is then performed in a manner that leaves the close-packed MPN's 340 on the surface 302 in the areas that were not occupied by the sacrificial material 304. It may be helpful, but not required to oxidize the MPN's 340 as described herein (by, e.g., UVO oxidation) before removing the sacrificial material 304.

Selection of the sacrificial material 304 preferably takes into account that the process and/or materials required to remove the sacrificial material 304 (and the MPN's 340 thereon) does not also remove the MPN's that are located on the surface 302 in the areas not occupied by the sacrificial material 304. For example, if the sacrificial material 304 is removed by one or more solvents, it may be preferred that the solvents used to remove the sacrificial material 304 do not also remove the MPN's 340 from the substrate 300 in the areas not occupied by the sacrificial material 304. One example may be the use of a photoresist for the sacrificial material 304 that is soluble in polar solvents such as, e.g., acetone or methyl alcohol. Dodecanethiol-coated MPN's are not soluble in polar solvents and, thus, would remain on the substrate 300 after removal of the photoresist and the MPN's located thereon.

Oxidation of Protective Molecules

The transfer and printing techniques described herein can be used to provide close-packed MPN arrays on substrates. In some instances, however, it may be preferred to remove the protective molecules surrounding the nanoparticle cores to, e.g., increase electrical conductivity of the MPN array.

For example, MPN's in the form of metallic nanoparticle cores (e.g., gold) with alkanethiol protective molecules (e.g., dodecanethiol) may exhibit relatively high electrical resistance because the alkanethiol molecules provide a dielectric layer between the metallic cores. To increase the electrical conductivity of the MPN array, it may be necessary to oxidize and/or remove the alkanethiol molecules.

As the alkanethiol coat around the nanoparticle cores is removed, it may be preferred that the average lateral spacing of nanoparticle cores (where the lateral spacing is measured parallel to the surface of the underlying substrate) in each layer of the film is not significantly altered. If the MPN structure includes two or more layers of MPN arrays, however, the average vertical spacing between the layers may decrease. The electrical resistance of a dielectric barrier increases exponentially with the width of the barrier. Thus, if the average vertical spacing between layers of the MPN arrays decreases, the ease by which electrons can hop back and forth between particles in adjacent layers increases and the electrical conductivity of the film is increased.

A number of methods are available for removing alkanethiol molecules from the surface of a nanoparticle core. These vary from reactive replacement by small organic molecules in a liquid solvent to heating the film to mobilize the alkanethiol molecules and sinter the Au particles. Neither of these methods is desirable, however. The first is extremely slow and has proven ineffective. The second destroys the ordered structure, small grain size, and smooth surface of film.

In connection with the present invention, a method has been developed that involves low temperature oxidation by exposing the nanoparticles to an oxidizing gas such as, e.g., ozone. By low temperature, it is meant that the process is typically performed at or near room temperature (e.g., 20 degrees Celsius). It may further be preferred that ultraviolet radiation be directed at the nanoparticles while exposing the nanoparticles to the oxidizing gas in an enclosed chamber. The ultraviolet radiation may preferably include selected wavelengths that, e.g., enhance the oxidation process. It may be preferred that the ozone be generated by UV radiation (e.g., at wavelengths of 253.7 nm and 184.9 nm) in an oxygen atmosphere in an enclosed chamber using, e.g., a commercial UVO cleaning apparatus.

Potential advantages of this method may include, e.g., its simplicity, speed, and low cost. In addition, the oxidation methods of the present invention may provide the opportunity to adjust the average tunnel resistance between the nanoparticle cores in a controlled manner. Thus, the oxidative methods of the present invention may allow more or less continuous control of electrical resistance in a nanoparticle structure. In conjunction with the present invention, low temperature oxidation by contacting MPN's in a structured film with an oxidizing gas (such as, e.g., ozone) while directing ultraviolet energy at the structured film will be termed UVO oxidation.

In addition to its gentle nature and low cost, UVO oxidation of protective alkanethiol molecules may also provide important advantages over other methods of converting films of Au MPN's into low-resistance conductors. Although not wishing to be bound by theory, it is theorized that the effect of ozone on alkanethiol molecules is twofold. First, there is a shortening of the alkane chains. Second, there is oxidation of the sulfur atoms in the alkanethiol molecules. The sulfur atoms may remain on the surface of the nanoparticle cores, but, in the case of Au nanoparticle cores, are no longer bonded via a gold-thiolate bond. The sulfur atoms are, instead, bonded by a much weaker ionic bond as a sulfate or sulfonate. The gradual conversion of the alkanethiol molecules to shortened, weakly bound organic species that are still adsorbed on the surface of the nanoparticle cores preserves the compact granular structure of the nanoparticle structure. Preservation of the structure of nanoparticle arrays may be improved if the UVO oxidation time is limited to, e.g., about 30 minutes or less, in some instances about 15 minutes or less.

Another potential advantage of oxidation of protective alkanethiol molecules is that the size and lateral spacing of the nanoparticles in the arrays (mono or multilayer) may preferably remain essentially unchanged during UVO oxidation, although the vertical thickness of multilayer nanoparticle array structures decreases and its their electrical conductivity increases.

Because the lateral dimensions (where lateral is generally parallel to the substrate surface) of the nanoparticle array structures preferably remain constant, lateral stress at the nanoparticle array structure/substrate interface may be reduced and the oxidized nanoparticle array structures preferably tightly adhere to substrate surfaces such as, e.g., SiO₂, Si₃N₄, and quartz. For example, neither oxidized nor un-oxidized multilayer nanoparticle array structures with Au cores can be removed by pressure sensitive adhesive tape (e.g., SCOTCH tape available from 3M Company, St. Paul, Minn.) from SiO₂ and quartz substrates that have been pretreated with HDMS.

It should be understood that lateral stability of the nanoparticle structures may be somewhat dependent on the size of the nanoparticle cores in the structures. For example, gold nanoparticle cores with a 10 nm diameter may form more laterally stable oxidized structures than smaller (e.g., 5 nm diameter) gold core nanoparticles.

Finally, the fact that the metal nanoparticle cores remain isolated from each other by a dielectric barrier even as the conductivity of the nanoparticle structure approaches that of a bulk metal may provide some advantages with regard to the electron transport mechanism in the nanoparticle structure. Electron transport in structures produced using the methods and apparatus of the present invention is via electron tunneling or hopping between nanoparticle cores. As a result, the optical transparency of the structure may be high, and the temperature dependence of electrical conductivity is preferably low.

Thus, the present invention may provide the opportunity to manufacture unique electrically conductive nanoparticle structures through oxidation, preferably in the presence of ultraviolet radiation.

Exchange Reactions within MPN Array Structures

After molecularly protected nanoparticle arrays are assembled into a desired structure on a substrate, it may be preferred to remove the organic molecules encasing MPN's and, in some cases, to replace these molecules with other molecules. Preferably this removal and/or replacement is performed in such a manner that it does not destroy the array structure on the substrate surface.

One potential method of achieving molecular replacement, especially in the case of a multilayer nanoparticle array structure, is to immerse the substrate supporting the nanoparticle structure in a solution containing the replacement molecule and a solvent in which both the replacement molecules and the molecules protecting the nanoparticles are soluble. The problem with this approach is that often the nanoparticles disperse in the solvent and the nanoparticle film “dissolves”.

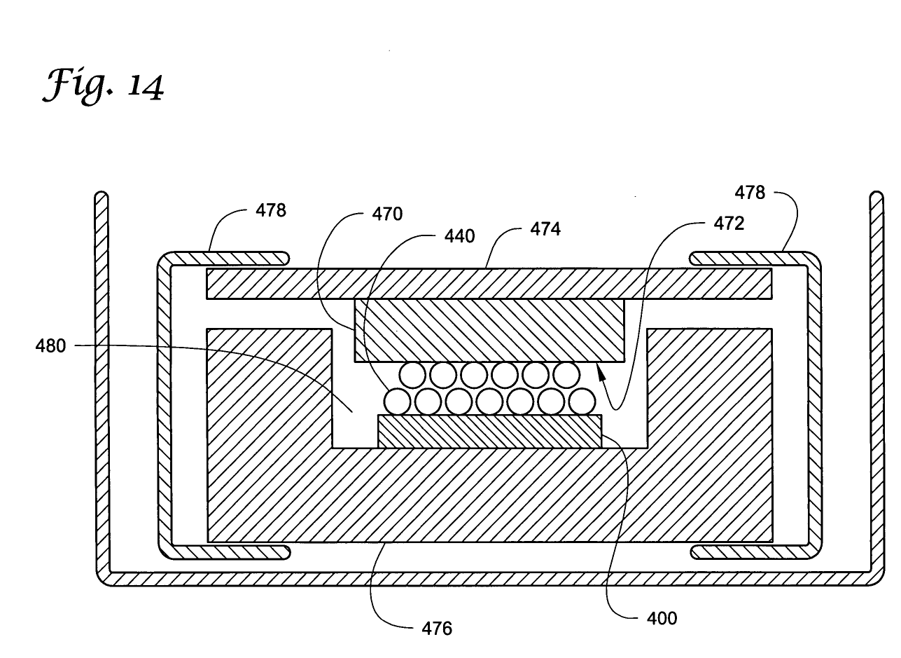

The present invention provides a novel technique and apparatus for solving this problem. This method and apparatus is illustrated schematically in FIG. 14. A substrate 400 supporting a MPN array structure formed from individual MPN's 440 is placed within a container. An exchange surface 472 on a body 470 is brought into contact with the MPN array structure under pressure. That pressure may preferably be supplied by a clamping structure that includes fixture 476 in which substrate 400 is located, plate 474 located opposite from the fixture 476, and clamps 478 that preferably urge the plate 474 towards the fixture 476. The plate 474 acts on body 470 to urge exchange surface 472 into contact with the MPN array structure on substrate 400.

The MPN array structure is then immersed in a solution that contains the replacement molecules. For example, the container may be filled with an amount of the replacement molecule solution sufficient to fill the volume 480, thus immersing the MPN array on the substrate 400 in the replacement molecule solution. The solution containing the replacement molecules preferably includes a solvent in which both the replacement molecules and the protective molecules on the MPN's 440 are soluble.

It may be preferred that the exchange surface 472 be porous such that the replacement molecules and the protective molecules on the MPN's 440 can move into and out of the pores in the exchange surface 472, but the larger nanoparticle cores in the MPN's 440 cannot enter the pores. Thus, the exchange surface 472 serves as a membrane that is capable of imbibing the replacement and protective molecules, but which holds the nanoparticle cores in place on the substrate 400. One preferred material for the exchange surface may be, e.g., polydimethylsiloxane (PDMS).

Although the method described above can result in exchange of the replacement molecules for the protective molecules on the MPN's 440, the exchange process may be enhanced if the MPN array structure is at least partially oxidized before being contacted with the replacement molecule solution.

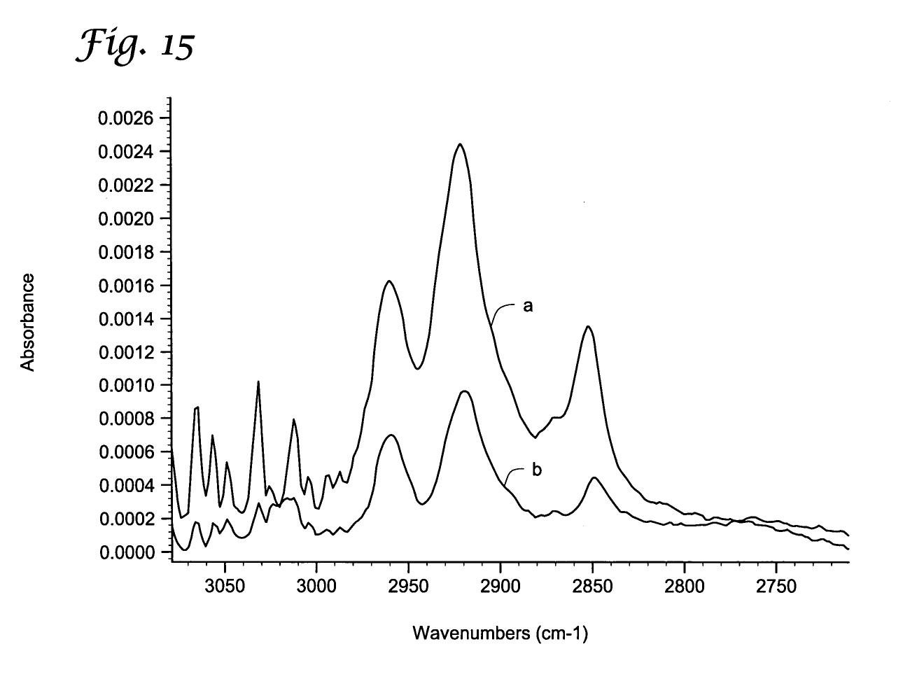

The limited nature of exchange of replacement molecules may be illustrated in FIG. 15, which presents FTIR data for the exchange of xylyl dithiol (XYL) for dodecanethiol (DDT) on a monolayer film of 10 nm Au MPN's printed on a quartz substrate. Curve a) is for an as prepared sample. Curve b) is for the same sample after it has been exposed to a solution of XYL in acetonitrile for 24 hours. Even after an exposure to XYL in acetonitrile for 24 hours, these IR spectra indicate the presence of DDT on the Au particles. Retention of a portion of the alkanethiol molecules in multilayer films of Au MPN's may be even more pronounced.

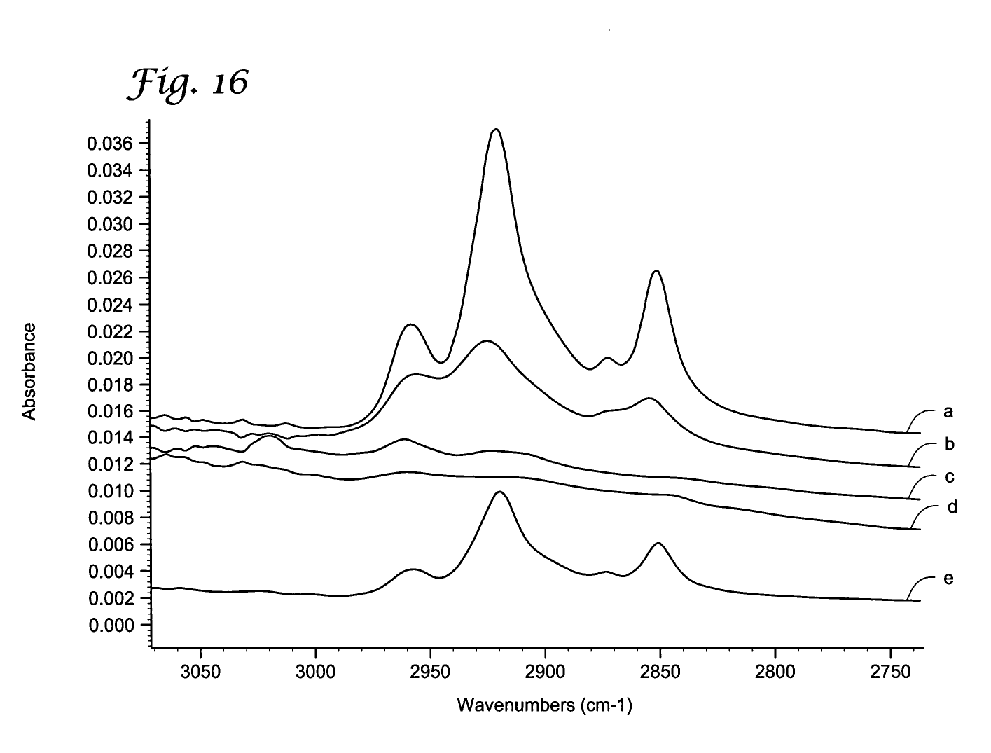

However, if a multilayer nanoparticle array structure is exposed to UVO oxidation as described herein, the exchange reaction may be greatly enhanced. One example of an oxidation-enhanced exchange reaction is illustrated in FIG. 16. The FTIR spectra plotted in this figure are for a 4-layer film of 10 nm Au MPN's coated with DDT molecules. Curve a) is for the original nanoparticle structure prepared using DDT coated particles. Curve b) is for the nanoparticle structure film after 15 minutes of UVO oxidation. Curve c) is after immersion of the nanoparticle structure in a XYL/acetonitrile solution using an apparatus similar to that depicted in FIG. 14 for six hours. This curve not only shows a dramatic decrease in the peaks associated with DDT but also has a small peak at 3022 cm⁻¹ due to the benzene ring of XYL. Finally, the sample is exposed to an additional 5 minutes of UVO oxidation (Curve d) and immersion in DDT/ethanol for six hours (Curve e).

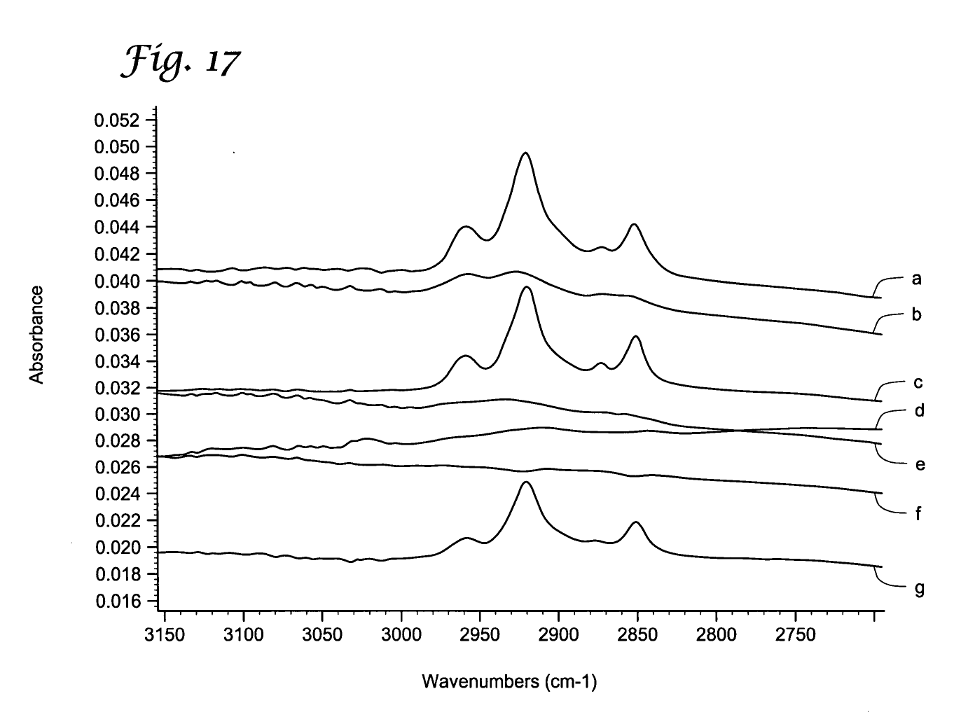

The final IR spectra (curve e) indicate that after this entire process the nanoparticle structure is still able to re-adsorb a substantial number of DDT molecules. FIG. 17 illustrates that with less severe UVO oxidation the molecular exchange process on multilayer Au nanoparticle structures can be made to be almost completely reversible. The data in this figure are for a bilayer nanoparticle structure of 10 nm Au core MPN's printed on a quartz substrate and exposed to a sequence of oxidations and molecular replacement reactions. The various curves correspond to: a) nanoparticle structure as prepared, b) after UVO oxidation for 5 minutes, c) after 6 hour immersion in DDT/ethanol, d) after UVO oxidation for 5 minutes, e) after 6 hour immersion in XYL/acetonitrile, f) after UVO oxidation for 5 minutes, and g) after 6 hour immersion in DDT/ethanol.

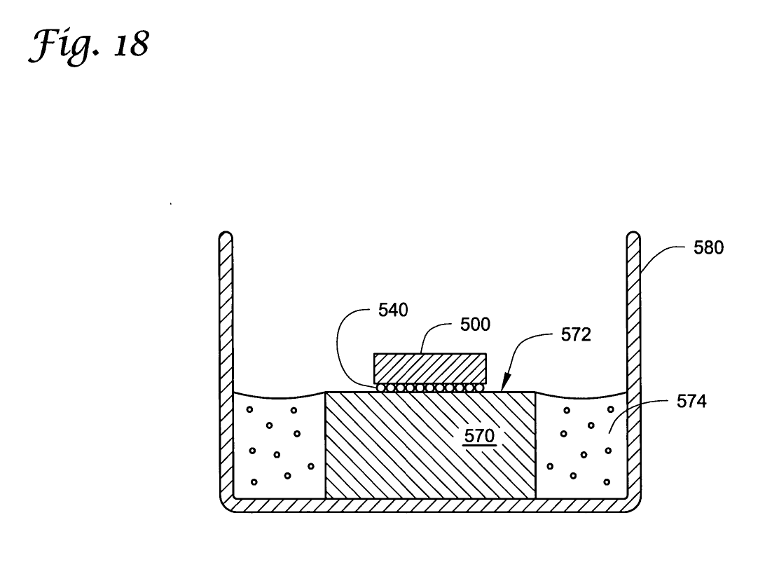

Although the clamping exchange apparatus of FIG. 14 may provide one approach to exchange of protective molecules with replacement molecules, other approaches may also be used. For example, FIG. 18 depicts another apparatus in which the exchange of replacement molecules for the protective molecules on MPN's in an array structure may be accomplished using a replacement solution as described above with respect to FIG. 14.

In the apparatus of FIG. 18, a substrate 500 is placed with the MPN array structure facing the exchange surface 572 of body 570. The exchange surface 572 may preferably be porous with a pore size that is capable of passing the replacement molecules and the protective molecules on the MPN's 540, but that does not pass the larger nanoparticle cores of the MPN's. The body 570 may then be placed in a solution 574 that includes the replacement molecules such that the replacement molecule solution diffuses through the exchange surface to the MPN array where exchange of the protective molecules for the replacement molecules occurs. To expedite the exchange process, it may be preferred that the exchange surface 572 have imbibed the replacement molecule solution before the substrate 500 is placed thereon.

In the apparatus of FIG. 18, it may be preferred that any additional replacement solution in the container 580 in which the body 570 is located not overflow the exchange surface 572. By keeping the additional replacement molecule solution below the exchange surface 572, the exchange reactions may preferably occur through the exchange surface 572 only, thus providing some restraint to the nanoparticle cores to enhance the integrity of the nanoparticle array structure during the exchange process.

As with the method and apparatus of FIG. 14, the exchange reactions using the methods and apparatus of FIG. 18 may also be enhanced by oxidizing the MPN array structure before contact with the replacement solution.

Among the many different exchange reactions that may be accomplished, it may be desirable to use replacement molecules that impart some selected functionality to the nanoparticle array structure. For example, attaching known photoactive or fluorophore molecules such as, e.g., pyrenes or porphyrins to metallic nanoparticles (e.g., Au) in an array structure using the methods described herein may preferably render the array photosensitive. The exchange may be accomplished by first chemically attaching a binding group (such as an alkyl thiol or alkyl amine) to the photoactive species or by replacing the protective molecules on the nanoparticles with linking molecules such as pyridinethiol or 1,4-phenylene diisocyanide which strongly adsorb the photoactive species and then exposing the close-packed array to the photoactive molecule in an organic solvent.

Biosensitive structures may be provided in connection with the present invention by exchanging the protective molecules for biological binding ligands. Such an exchange may be relatively straightforward when the biological molecules adsorb on hydrophobic surfaces because they may be absorbed from either an aqueous or organic solvent solution into a hydrophobic MPN array structure. If the biological binding ligands adsorb only on hydrophilic surfaces, the MPN array structure may need to be made hydrophilic before functionalization with the biological molecules (by, e.g., oxidation of the MPN array, preferably by UVO).

### EXAMPLES

Various aspects of the present invention may be illustrated by the following examples. It is to be understood that the particular examples, materials, amounts, and procedures are to be interpreted broadly in accordance with the scope of the invention as set forth herein.

### EXAMPLE 1

### Protocol for Encapsulation of Au Nanoparticles with Dodecanethiol

Citrate stabilized Au nanoparticles having a narrow size distribution can be synthesized by addition of sodium citrate, Na₃C₆H₅O₇, to reduce chloroauric acid, HAuCl₄, in aqueous solution. These Au particles are well studied and are commercially available in a number of sizes. Citrate stabilized Au particles with nominal diameters of 5 nm and 10 nm were purchased from Ted Pella, Inc. In order to transform these charge stabilized particles into MPN's suitable for suspension in a non-polar solvent it is necessary to replace the citrate ions coating the particles with an alkanethiol like dodecanethiol (DDT). This replacement reaction takes place readily if a dilute solution of DDT in ethanol is mixed with the aqueous solution containing the citrate stabilized Au particles. A sample protocol for preparation of 5 nm and 10 nm diameter Au MPN's is as follows:
1. Mix 1 ml of 15 mM DDT/ethanol solution and 14 ml of ethanol in a glass beaker and stir.
2. Slowly add 15 ml of the stock Au particle suspension obtained from Ted Pella, Inc. drop-by drop while continuing to stir the mixture.
3. Divide the resulting suspension equally and pour into 15 ml plastic centrifuge tubes.
4. After waiting an hour for the particles to become encapsulated with DDT and to flock together centrifuge the particles to the bottom of the test tubes (2500 g for ½ hour), decant the liquid, and let the particles air dry at least 12 hours.
5. Each dried sample contains sufficient particles for making 1 ml of particle suspension for casting.
6. The particles are dispersed in the casting solvent by brief ultrasonic agitation in an ultrasonic bath and after equilibration in a glass test tube for an hour at 60 degrees C. are ready to be used in self-assembling a monolayer array. Results may be enhanced by dispersing the dry particles in the casting solvent shortly before use.

### EXAMPLE 2

### Solvents for Au Nanoparticle Colloidal Suspensions

For self-assembly of monolayer films of MPN's on an assembly surface as described herein, a suitable solvent must be found for the colloidal suspension. The solvent solution (which may be one solvent or a solvent mixture) is preferably lighter than the aqueous solution forming the assembly surface, immiscible with the aqueous solution, spread as a thin film on the assembly surface, evaporate relatively rapidly, and be able to disperse the nanoparticles as a uniform suspension.

If the spreading solvent is heavier than water or doesn't spread as a thin film, the colloidal suspension may puddle on the assembly surface and a disordered multilayer array may form. The requirement that the solvent evaporate rapidly is less severe, but a solvent that is less volatile than the aqueous solution of the assembly surface is typically not suitable for the colloidal suspension. Finally, if the nanoparticles are not well-dispersed in the solvent solution, they may not self-assemble into a well-ordered monolayer.

Five nanometer diameter Au particles that are encapsulated by dodecanethiol readily disperse in a number of organic solvents, such as n-hexane, 3-methylpentane, dichloromethane, toluene, and chloroform. One potentially preferred solvent solution for these nanoparticles is a 50/50 by volume mixture of n-hexane, (C₆H₁₄), and dichloromethane, (CH₂Cl₂). Ten nanometer diameter Au particles that are encapsulated by dodecanethiol are readily dispersed in chloroform. One potentially preferred solvent solution for these nanoparticles is a 60/40 by volume mixture of 3-methylpentane, (C₆H₁₄), and chloroform, (CHCl₃).

In both cases the solvent solution may preferably be designed to become less dense as evaporation proceeds. The resulting density gradient in the solvent layer may tend to suppress undesired convective motion and, thus, may improve the quality of the self-assembled monolayer.

### EXAMPLE 3

### Electrical Conductivity of Multilayer Arrays

In order to make accurate electrical conductivity measurements for the ultra-thin nanoparticle film structures of interest in the present invention, robust electrical contacts were deposited on the films. This was accomplished using a conventional copper TEM grid as a shadow mask and vacuum depositing 400 nm thick gold contact pads through this mask onto nanoparticle films printed on Si substrates.

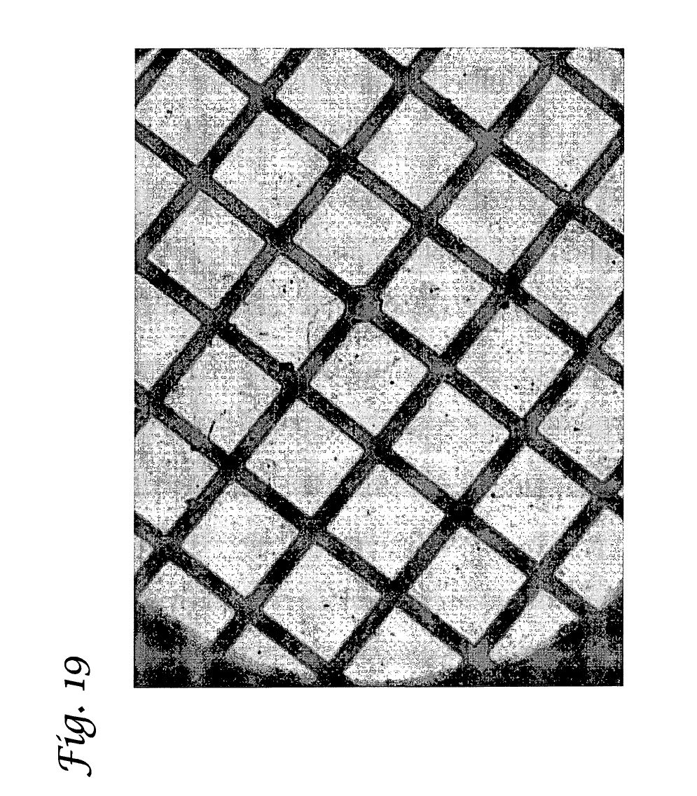

FIG. 19 is a TEM micrograph showing Au pads fabricated in this way with dimensions of 285 microns per side and a gap between pads of 55 microns. I-V characteristics of the film bridging the gap between pairs of pads were obtained using a semiconductor probe station and a Keithley semiconductor analyzer.

The sheet resistance of a 4-layer film of 10 nm Au MPN's was measured to be 2.4×10⁹ ohms per square as formed. The resistance of this film dropped to 9.1×10¹ ohms per square after 15 minutes of UVO oxidation (a decrease of 8 orders of magnitude). Using a thickness for the oxidized film of 20 nm obtained by AFM, this film had a resistivity of 1.8×10⁻⁴ ohm cm, which compares favorably to a value for bulk gold films of ˜1×10⁻⁵ ohm cm. The sheet resistance of a 6-layer film of 10 nm Au MPN's was 2.6×10¹¹ ohms per square as formed and only 2.9×10¹ ohms per square after 15 minutes of UVO oxidation. The thickness of the film after oxidation was 30 nm, yielding a resistivity of 8.7×10⁻⁵ ohm cm. I-V characteristics of this film were linear with currents as high as 80 mA at 1 V with no significant degradation of the film.

### EXAMPLE 4

### Chemical Changes Occurring During UVO Oxidation

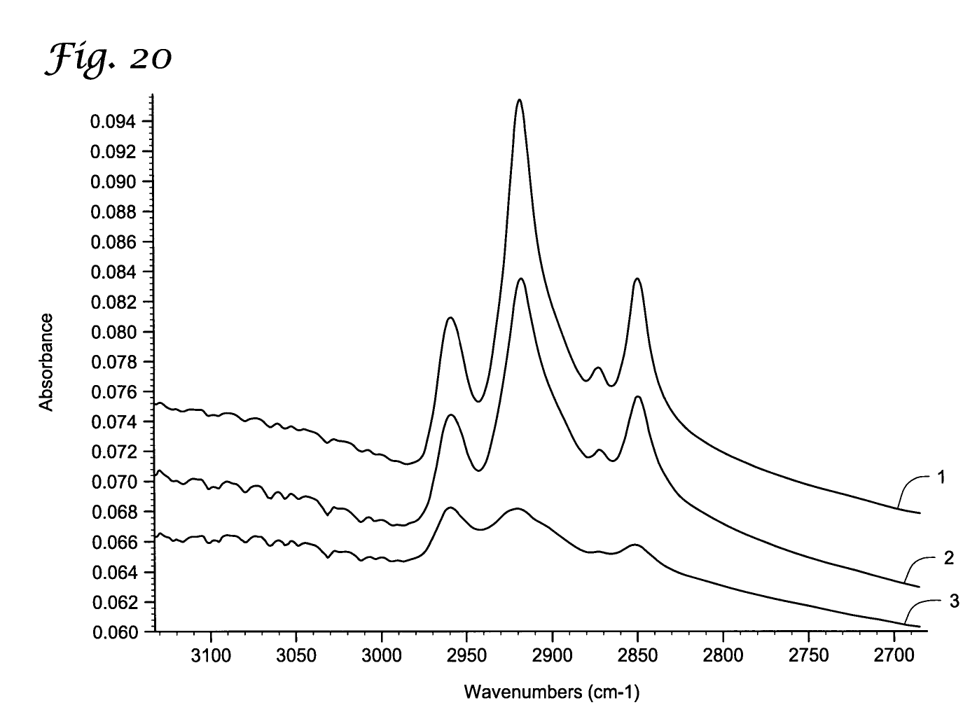

Dodecanethiol (DDT) has signature IR absorption peaks at 2918-2920 cm⁻¹ (for CH₂ asymmetric stretch), 2854 cm⁻¹ (for CH₂ symmetric stretch), and 2964 cm⁻¹ (for CH₃ stretching). Thus, IR absorption can be used to monitor the number of CH₂ and CH₃ species in a nanoparticle film. FIG. 20 is a plot of the FTIR spectra in this frequency region for a bilayer array of 10 nm Au dodecanethiol-coated MPN's printed on a quartz substrate. Three curves are plotted in this figure. The first (curve 1) is the IR spectra of an un-oxidized film. Curve 2 is for a film that was exposed for an hour to UV radiation in the presence of oxygen but with no ozone present. It is seen that there is little if any loss of CH₂ or CH₃ from this film. Curve 3 is for a film that was exposed to ozone for 15 minutes in an UVO cleaner. There is a dramatic decrease in the signal due to CH₁₂ and CH₃ in this case. It is also of interest to note that the peak corresponding to CH₃ stretching drops less than those corresponding to CH₂ stretching.

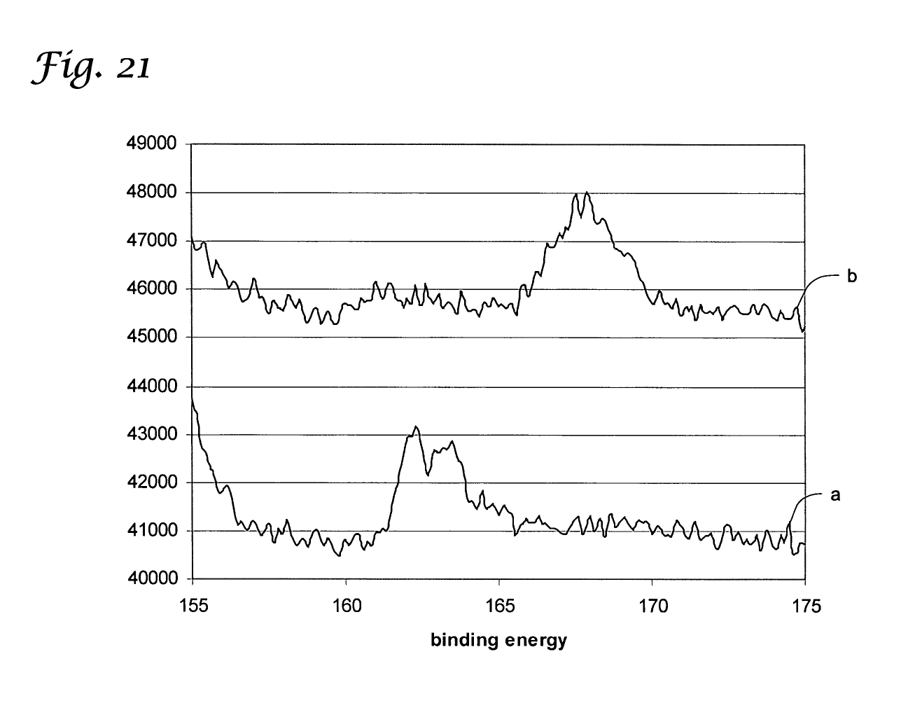

X-ray photoelectron spectroscopy (XPS) is a useful technique for determining the oxidation state of atoms in a sample. Each chemical element has a characteristic binding energy and which differs for different oxidation states. Sulfur has characteristic peaks at 161.5 eV and 162.5 eV when it is un-oxidized (as is the case for the gold-thiolate bond). Oxidized sulfur has peaks in the 168-170 eV range. FIG. 21 shows the shift from un-oxidized to oxidized sulfur for a 4-layer film of 10 nm Au dodecanethiol-coated MPN's after UVO oxidation for 15 minutes. Curve a) is before oxidation and curve b) is after UVO oxidation as described herein for 15 minutes. The number of sulfur atoms in the film appears to remain unchanged during UVO oxidation.

### EXAMPLE 5

### Structural Changes Occurring During UVO Oxidation

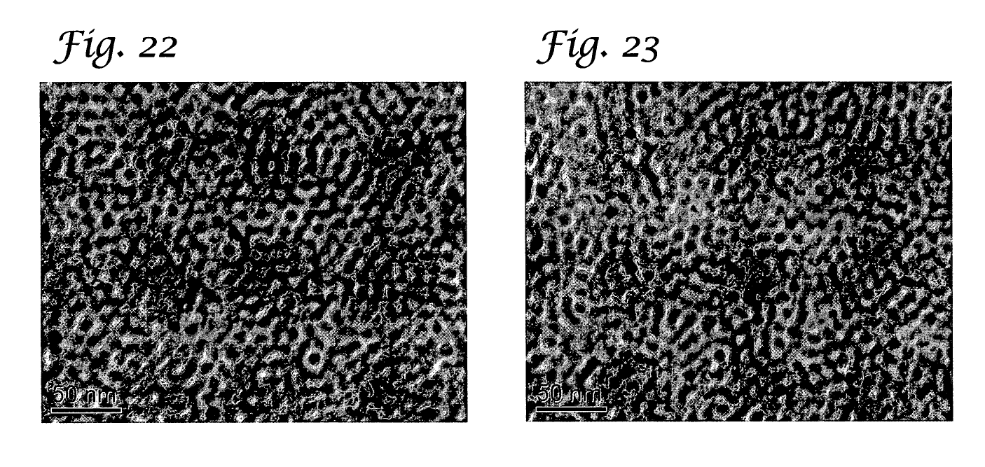

The size and lateral spacing of Au nanoparticles in a multilayer film produced by the methods and apparatus of this invention preferably remain unchanged during UVO oxidation up to the point where all protective species on the surface of the particles are removed. This is demonstrated in FIGS. 22 & 23, TEM micrographs taken for a 4-layer film of 10 nm dodecanethiol-coated Au MPN's printed on a thin silicon nitride membrane. FIG. 22 is taken before UVO oxidation and FIG. 23 is taken after 15 minutes of UVO oxidation as described herein.

AFM scans of multilayer films fabricated using the methods and apparatus of this invention confirm that the surface of these films is much smoother than films produced by other methods and that while the thickness of the films decreases during UVO oxidation the surface of the films remains smooth. An AFM study of a 4-layer film of 10 nm Au MPN's yielded an rms roughness of ˜2 nm, which is much less than the surface roughness of vacuum-evaporated gold films. After UVO oxidation for 15 minutes the rms roughness of this film became ˜3 nm. After UVO oxidation for 30 minutes the rms roughness became ˜8 nm, which is an indication that at this point there are few, if any, protective species coating the particles. The thickness of this film decreased from around 60-70 nm as prepared to 20-22 nm after 30 minutes of UVO oxidation.

### EXAMPLE 6

### Temperature Dependence of Electrical Conductivity

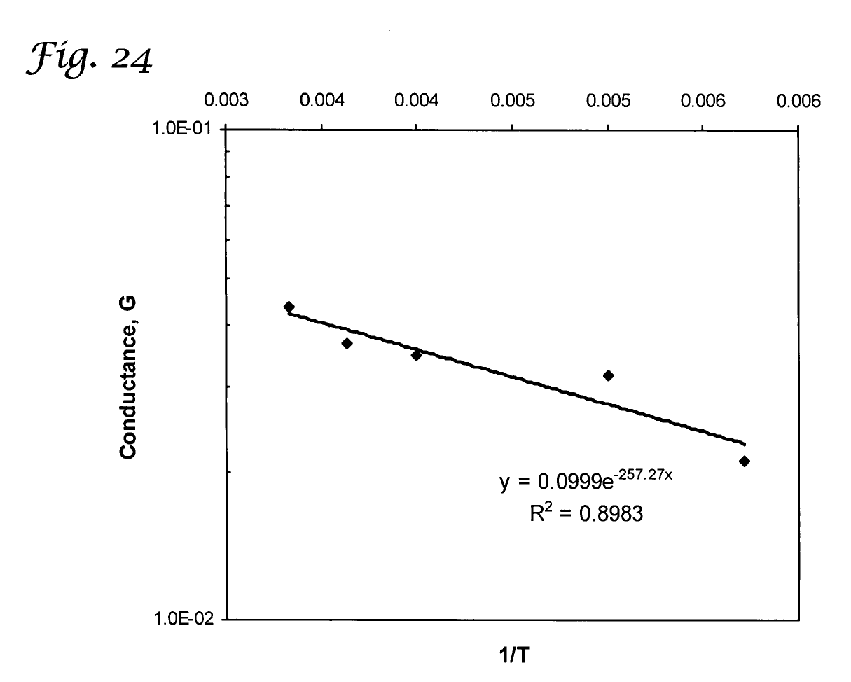

FIG. 24 is a plot of the logarithm of electrical conductance vs. the reciprocal of absolute temperature for a 6-layer film of 10 nm Au dodecanethiol-coated MPN's that was subjected to UVO oxidation as described herein for 15 minutes. This multilayer film is a low-resistance conductor and yet its electrical conductance varies exponentially with the reciprocal of absolute temperature.

As used herein and in the appended claims, the singular forms “a,” “and,” and “the” include plural referents unless explicitly limited to the singular form or the context clearly dictates otherwise.

The complete disclosures of all patents, patent applications including provisional patent applications, publications, and electronically available material (e.g. GenBank amino acid and nucleotide sequence submissions) cited herein or in the documents incorporated herein by reference. The foregoing detailed description and examples have been provided for clarity of understanding only. No unnecessary limitations are to be understood therefrom. The invention is not limited to the exact details shown and described; many variations will be apparent to one skilled in the art and are intended to be included within the invention defined by the claims.

What is claimed:

1. A method of self-assembling a nanoparticle array, the method comprising:
providing a body comprising an orifice formed therein, the orifice comprising an opening in an upper surface of the body;
forming an assembly surface within the orifice, wherein the assembly surface comprises a gas/aqueous solution interface, wherein the aqueous solution forms a surface comprising a convex upwards curvature within the orifice;
depositing a colloidal suspension on the assembly surface, wherein the colloidal suspension comprises hydrophobic nanoparticles suspended in an organic solvent solution, and wherein the colloidal suspension disperses over the assembly surface; and
evaporating the organic solvent from the assembly surface, wherein the hydrophobic nanoparticles form a monolayer nanoparticle array on at least a portion of the assembly surface.

2. A method according to claim 1, wherein the opening of the orifice comprises a circular opening.

3. A method according to claim 1, wherein the orifice is lined with a hydrophobic material.

4. A method according to claim 1, wherein the opening of the orifice comprises a step proximate the upper surface, wherein the opening widens at the step, and wherein the assembly surface comprises an edge located below the step.

5. A method according to claim 4, wherein the colloidal suspension comprises a gas/colloidal suspension interface within the orifice, wherein an edge of the gas/colloidal suspension interface is located above the step.

6. A method according to claim 4, wherein the colloidal suspension comprises a gas/colloidal suspension interface within the orifice, wherein an edge of the gas/colloidal suspension interface is located below the step after the colloidal mixture is deposited on the assembly surface, and wherein the method comprises raising the gas/colloidal suspension interface above the step.

7. A method according to claim 6, wherein raising the gas/colloidal suspension interface comprises raising the assembly surface to a position closer to the step after depositing the colloidal suspension on the assembly surface.

8. A method according to claim 1, wherein the organic solvent solution comprises a non-polar solvent.

9. A method according to claim 1, wherein the organic solvent solution is immiscible with the aqueous solution.

10. A method according to claim 1, wherein the organic solvent solution has a density less than the density of the aqueous solution.

11. A method according to claim 1, wherein the organic solvent solution comprises two or more organic solvents.

12. A method according to claim 1, wherein the organic solvent solution comprises two or more organic solvents, and further wherein the density of the organic solvent solution decreases during the evaporation.

13. A method according to claim 1, wherein the organic solvent solution comprises one or more solvents selected from the group consisting of n-hexane, 3-methylpentane, dichloromethane, toluene, and chloroform.

14. A method according to claim 1, wherein the hydrophobic nanoparticles comprise a hydrophobic coating encasing a core.

15. A method according to claim 1, wherein the hydrophobic nanoparticles comprise a hydrophobic monolayer coating encasing a core.

16. A method according to claim 1, wherein the hydrophobic coating comprises alkanethiol molecules.

17. A method according to claim 1, wherein the hydrophobic coating consists essentially of alkanethiol molecules.

18. A method according to claim 1, wherein the hydrophobic coating comprises dodecanethiol molecules.

19. A method according to claim 1, wherein the hydrophobic coating consists essentially of dodecanethiol molecules.

20. A method according to claim 1, wherein the aqueous solution consists essentially of water.

21. A method according to claim 1, wherein the aqueous solution comprises water and pyridinethiol.

22. A method according to claim 1, wherein the hydrophobic nanoparticles comprise a core and a hydrophobic coating on the core, wherein the core comprise atoms selected from the group consisting of one or more elements from the IIA, IIIA, IVA, VA, VIA, VIIA, IB, IIB, IIIB, and IVB columns of the periodic table, their oxides, nitrides and sulfides, and combinations thereof.

23. A method according to claim 1, wherein the hydrophobic nanoparticles comprise a core and a hydrophobic coating on the core, wherein the core comprise atoms selected from the group consisting of one or more of IIIB/VB and IIB/VIB semiconductor compounds.

24. A method according to claim 1, wherein the hydrophobic nanoparticles comprise a core and a hydrophobic coating on the core, wherein the core comprises one or more metals.

25. A method according to claim 1, wherein the hydrophobic nanoparticles comprise a core and a hydrophobic coating on the core, wherein the core consists essentially of one or more metals.

26. A method according to claim 1, wherein the hydrophobic nanoparticles comprise a core consisting essentially of Au.

27. A method according to claim 1, wherein the hydrophobic nanoparticles comprise a core consisting essentially of Au and a hydrophobic coating encasing the core.

28. A method of transferring a nanoparticle array to a solid surface, the method comprising:
providing a monolayer nanoparticle array within an orifice formed in a body, wherein the orifice comprises an opening in an upper surface of the body, wherein the nanoparticle array is located on an assembly surface that is located below the upper surface of the body, wherein the assembly surface comprises a surface formed by an aqueous solution, and wherein the assembly surface comprises a convex upwards curvature within the orifice; and
raising the assembly surface and the monolayer nanoparticle array located thereon towards the upper surface of the body, wherein at least a portion of the monolayer nanoparticle array contacts a solid surface, wherein the portion of the monolayer nanoparticle array in contact with the solid surface remains on the solid surface and forms a nanoparticle array thereon.

29. A method according to claim 28, wherein the solid surface comprises an elastomeric surface.

30. A method according to claim 29, wherein the solid surface comprises PDMS.

31. A method according to claim 28, wherein the opening of the orifice comprises a circular opening.

32. A method according to claim 28, wherein the orifice is lined with a hydrophobic material.

33. A method according to claim 28, wherein the opening of the orifice comprises a step proximate the upper surface, wherein the opening widens at the step, and wherein the assembly surface comprises an edge located below the step.

34. A method according to claim 33, wherein the edge of the assembly surface remains below the step before the monolayer nanoparticle array contacts the solid surface.

35. A method according to claim 28, wherein the hydrophobic nanoparticles comprise a hydrophobic coating encasing a core.

36. A method according to claim 28, wherein the hydrophobic nanoparticles comprise a hydrophobic monolayer coating encasing a core.

37. A method according to claim 28, wherein the hydrophobic coating comprises alkanethiol molecules.

38. A method according to claim 28, wherein the hydrophobic coating consists essentially of alkanethiol molecules.

39. A method according to claim 28, wherein the hydrophobic coating comprises dodecanethiol molecules.

40. A method according to claim 28, wherein the hydrophobic coating consists essentially of dodecanethiol molecules.

41. A method according to claim 28, wherein the aqueous solution consists essentially of water.

42. A method according to claim 28, wherein the aqueous solution comprises water and pyridinethiol.

43. A method according to claim 28, wherein the hydrophobic nanoparticles comprise a core and a hydrophobic coating on the core, wherein the core comprise atoms selected from the group consisting of one or more elements from the IIA, IIIA, IVA, VA, VIA, VIIA, IB, IIB, IIIB, and IVB columns of the periodic table, their oxides, nitrides and sulfides, and combinations thereof.

44. A method according to claim 28, wherein the hydrophobic nanoparticles comprise a core and a hydrophobic coating on the core, wherein the core comprise atoms selected from the group consisting of one or more of IIIB/VB and IIB/VIB semiconductor compounds.

45. A method according to claim 28, wherein the hydrophobic nanoparticles comprise a core and a hydrophobic coating on the core, wherein the core comprises one or more metals.

46. A method according to claim 28, wherein the hydrophobic nanoparticles comprise a core and a hydrophobic coating on the core, wherein the core consists essentially of one or more metals.

47. A method according to claim 28, wherein the hydrophobic nanoparticles comprise a core consisting essentially of Au and a hydrophobic coating encasing the core.

48. A method of forming a multilayer nanoparticle array on a solid surface, the method comprising:
providing a first monolayer nanoparticle array within a first orifice formed in a first body, wherein the first orifice comprises an opening in an upper surface of the first body, wherein the first monolayer nanoparticle array is located on a first assembly surface that is located below the upper surface of the first body, wherein the first assembly surface comprises a surface formed by an aqueous solution, and wherein the first assembly surface comprises a convex upwards curvature within the first orifice; and
raising the first assembly surface and the first monolayer nanoparticle array located thereon towards the upper surface of the first body, wherein at least a portion of the first monolayer nanoparticle array contacts a solid surface, wherein the portion of the first monolayer nanoparticle array in contact with the solid surface remains on the solid surface;
providing a second monolayer nanoparticle array within a second orifice formed in a second body, wherein the second orifice comprises an opening in an upper surface of the second body, wherein the second monolayer nanoparticle array is located on a second assembly surface that is located below the upper surface of the second body, wherein the second assembly surface comprises a surface formed by an aqueous solution, and wherein the second assembly surface comprises a convex upwards curvature within the second orifice; and
raising the second assembly surface and the second monolayer nanoparticle array located thereon towards the upper surface of the second body, wherein at least a portion of the second monolayer nanoparticle array contacts the first monolayer nanoparticle array on the solid surface, wherein the portion of the second monolayer nanoparticle array in contact with the first monolayer nanoparticle array remains on the first monolayer nanoparticle array after the second assembly surface moves away from the solid surface, wherein the first monolayer nanoparticle array on the solid surface and the second monolayer nanoparticle array attached thereto form a multilayer nanoparticle array on the solid surface.

49. A method according to claim 48, wherein the first orifice and the second orifice are the same orifice.

50. A method according to claim 48, wherein the nanoparticles in the first monolayer nanoparticle array comprise the same composition as the nanoparticles in the second monolayer nanoparticle array.

51. A method according to claim 48, wherein the nanoparticles in the first monolayer nanoparticle array comprise a different composition as the nanoparticles in the second monolayer nanoparticle array.

52. A method according to claim 48, wherein the solid surface comprises an elastomeric surface.

53. A method according to claim 52, wherein the solid surface comprises PDMS.

54. A method according to claim 48, further comprising forming and transferring additional monolayer nanoparticle arrays to the multilayer nanoparticle array on the solid surface.

55. A method of printing a nanoparticle array on a substrate, the method comprising:
providing a monolayer nanoparticle array within an orifice formed in a body, wherein the orifice comprises an opening in an upper surface of the body, wherein the nanoparticle array is located on an assembly surface that is located below the upper surface of the body, wherein the assembly surface comprises a surface formed by an aqueous solution, and wherein the assembly surface comprises a convex upwards curvature within the orifice;
contacting the monolayer nanoparticle array with a transfer surface, wherein at least a portion of the monolayer nanoparticle array in contact with the transfer surface remains on the transfer surface and forms at least a portion of a nanoparticle array on the transfer surface;
contacting a substrate surface with the nanoparticle array on the transfer surface; and
removing the transfer surface from proximity to the substrate surface, wherein at least a portion of the nanoparticle array on the transfer surface remains on the substrate surface after removing the transfer surface from proximity to the substrate surface.

56. A method according to claim 55, wherein the transfer surface comprises raised areas and recessed areas located between the raised areas, wherein the monolayer nanoparticle array transfers to at least the raised areas, and further wherein only the raised areas contact the substrate surface, wherein only the portions of the monolayer nanoparticle array on the raised areas remain on the substrate surface after removing the transfer surface from proximity to the substrate surface.

57. A method according to claim 55, wherein the transfer surface comprises an elastomeric surface.

58. A method according to claim 55, wherein the transfer surface is hydrophobic.

59. A method according to claim 55, wherein the opening of the orifice comprises a circular opening.

60. A method according to claim 55, wherein the orifice is lined with a hydrophobic material.

61. A method according to claim 55, wherein the opening of the orifice comprises a step proximate the upper surface, wherein the opening widens at the step, and wherein the assembly surface comprises an edge located below the step.

62. A method according to claim 61, wherein the edge of the assembly surface remains below the step before the nanoparticle array contacts the transfer surface.

63. A method according to claim 55, wherein contacting the nanoparticle array with a transfer surface comprises raising the assembly surface and the nanoparticle array located thereon towards the upper surface of the body.

64. A method according to claim 55, wherein the hydrophobic nanoparticles comprise a hydrophobic coating encasing a core.

65. A method according to claim 55, wherein the hydrophobic nanoparticles comprise a hydrophobic monolayer coating encasing a core.

66. A method according to claim 55, wherein the hydrophobic coating comprises alkanethiol molecules.

67. A method according to claim 55, wherein the hydrophobic coating consists essentially of alkanethiol molecules.

68. A method according to claim 55, wherein the hydrophobic coating comprises dodecanethiol molecules.

69. A method according to claim 55, wherein the hydrophobic coating consists essentially of dodecanethiol molecules.

70. A method according to claim 55, wherein the aqueous solution consists essentially of water.

71. A method according to claim 55, wherein the aqueous solution comprises water and pyridinethiol.

72. A method according to claim 55, wherein the hydrophobic nanoparticles comprise a core and a hydrophobic coating on the core, wherein the core comprise atoms selected from the group consisting of one or more elements from the IIA, IIIA, IVA, VA, VIA, VIIA, IB, IIB, IIIB, and IVB columns of the periodic table, their oxides, nitrides and sulfides, and combinations thereof.

73. A method according to claim 55, wherein the hydrophobic nanoparticles comprise a core and a hydrophobic coating on the core, wherein the core comprise atoms selected from the group consisting of one or more of IIIB/VB and IIB/VIB semiconductor compounds.

74. A method according to claim 55, wherein the hydrophobic nanoparticles comprise a core and a hydrophobic coating on the core, wherein the core comprises one or more metals.

75. A method according to claim 55, wherein the hydrophobic nanoparticles comprise a core and a hydrophobic coating on the core, wherein the core consists essentially of one or more metals.

76. A method according to claim 55, wherein the hydrophobic nanoparticles comprise a core consisting essentially of Au and a hydrophobic coating encasing the core.

77. A method of providing a nanoparticle array on a substrate, the method comprising:
providing a monolayer nanoparticle array within an orifice formed in a body, wherein the orifice comprises an opening in an upper surface of the body, wherein the nanoparticle array is located on an assembly surface that is located below the upper surface of the body, wherein the assembly surface comprises a surface formed by an aqueous solution, and wherein the assembly surface comprises a convex upwards curvature within the orifice;
contacting the monolayer nanoparticle array with a solid surface comprising a sacrificial material covering portions of the solid surface, wherein at least a portion of the monolayer nanoparticle array in contact with the transfer surface remains on the solid surface and the sacrificial material;
removing the sacrificial material from the solid surface, wherein any nanoparticles on the sacrificial material are removed with the sacrificial material such that a patterned nanoparticle array is formed on the solid surface.

78. A method according to claim 77, wherein the sacrificial material comprises photoresist.

79. A method according to claim 77, wherein removal of the sacrificial material does not remove the nanoparticles located directly on the solid surface.

80. A method of removing a coating from nanoparticles in a film, the method comprising:
providing a substrate comprising at least one structured nanoparticle array located on a surface of the substrate, wherein each of the nanoparticles is coated with organic molecules; and
removing at least some of the organic molecules from at least some of the nanoparticles by exposing the nanoparticles to an oxidizing gas.

81. A method according to claim 80, further comprising exposing the at least one structured monolayer nanoparticle array to ultraviolet radiation while exposing the nanoparticles to the oxidizing gas.

82. A method according to claim 80, wherein lateral spacing of the nanoparticles with each structured monolayer is essentially unchanged after removal of the organic molecules.

83. A method according to claim 80, wherein the oxidizing gas comprises ozone.

84. A method according to claim 80, wherein the organic molecules comprise alkanethiol molecules.

85. A method according to claim 80, wherein the organic molecules of each nanoparticle form a coating encasing a core of the nanoparticle.

86. A method according to claim 85, wherein the coating consists essentially of alkanethiol molecules.

87. A method according to claim 85, wherein the coating comprises dodecanethiol molecules.

88. A method according to claim 85, wherein the coating consists essentially of dodecanethiol molecules.

89. A method according to claim 80, wherein the at least one structured nanoparticle array comprises a multilayer structured nanoparticle array, wherein each layer of the multilayer structured nanoparticle array comprises a monolayer array of nanoparticles.

90. A method of modifying a nanoparticle array on a substrate, the method comprising:
providing a solid substrate comprising at least one structured nanoparticle array located on a surface of the substrate, wherein each of the nanoparticles is coated with organic molecules; and
contacting the at least one structured nanoparticle array with replacement molecules while contacting the at least one structured nanoparticle array with an exchange surface, wherein at least some of the replacement molecules exchange with at least some of the organic molecules coating the nanoparticles; and
removing the exchange surface from the at least one structured nanoparticle array, wherein at least some of the nanoparticles retain exchanged replacement molecules after removal of the exchange surface.

91. A method according to claim 90, wherein lateral spacing of the nanoparticles with each structured monolayer nanoparticle array is essentially unchanged after exchange of the organic molecules for the replacement molecules.

92. A method according to claim 90, wherein the exchange surface comprises a porous material in which the replacement molecules are imbibed before the exchange surface contacts the at least one structured monolayer nanoparticie array.

93. A method according to claim 92, wherein the porous material of the exchange surface is located in a solution containing additional replacement molecules.

94. A method according to claim 90, wherein the exchange surface comprises a porous material, and wherein the exchange surface and the substrate surface on which the at least one structured monolayer nanoparticle array is located are both immersed in a solution containing the replacement molecules.

95. A method according to claim 90, wherein the organic molecules comprise alkanethiol molecules.

96. A method according to claim 90, wherein the organic molecules of each nanoparticle form a coating encasing a core of the nanoparticle.

97. A method according to claim 96, wherein the coating consists essentially of alkanethiol molecules.

98. A method according to claim 96, wherein the coating comprises dodecanethiol molecules.

99. A method according to claim 96, wherein the coating consists essentially of dodecanethiol molecules.

100. A method according to claim 90, wherein the at least one structured monolayer nanoparticle array comprises a multilayer structured nanoparticle array on the substrate surface.

101. A method according to claim 90, wherein the at least one structured monolayer nanoparticle array comprises a monolayer structured nanoparticle array on the substrate surface.

102. A method according to claim 90, further comprising removing at least some of the organic molecules from at least some of the nanoparticles by exposing the nanoparticles to an oxidizing gas.

103. A method according to claim 102, further comprising exposing the at least one structured monolayer nanoparticle array to ultraviolet radiation while exposing the nanoparticles to the oxidizing gas.

104. A method according to claim 102, wherein lateral spacing of the nanoparticles with each structured monolayer nanoparticle array is essentially unchanged after removal of the organic molecules.

105. A method according to claim 102, wherein the oxidizing gas comprises ozone.

106. A method of providing a nanoparticle array on a surface, the method comprising:
providing a body comprising an orifice formed therein, the orifice comprising an opening in an upper surface of the body;
forming an assembly surface using an aqueous solution within the orifice, wherein the assembly surface forms a gas/aqueous solution interface, wherein the assembly surface comprises a convex upwards curvature within the orifice;
depositing a colloidal suspension on the assembly surface, wherein the colloidal suspension comprises hydrophobic nanoparticles suspended in an organic solvent solution, and wherein the colloidal suspension disperses over the assembly surface; and
evaporating the organic solvent from the assembly surface, wherein the hydrophobic nanoparticles form a monolayer nanoparticle array on at least a portion of the assembly surface;
contacting the monolayer nanoparticle array with a transfer surface, wherein at least a portion of the monolayer nanoparticle array in contact with the transfer surface remains on the transfer surface and forms at least one layer of a nanoparticle array on the transfer surface;
contacting a solid substrate surface with the nanoparticle array on the transfer surface;
removing the transfer surface from proximity to the substrate surface, wherein at least a portion of the nanoparticle array on the transfer surface remains on the substrate surface after removing the transfer surface from proximity to the substrate surface;
removing at least some organic molecules from at least some of the hydrophobic nanoparticles in the nanoparticle array on the substrate surface by exposing the hydrophobic nanoparticles to an oxidizing gas;
contacting the nanoparticles in the nanoparticle array on the substrate surface with replacement molecules while contacting the nanoparticle array with an exchange surface, wherein at least some of the replacement molecules exchange with at least some of the organic molecules remaining on the nanoparticles after exposing the hydrophobic nanoparticles to an oxidizing gas; and
removing the exchange surface from the nanoparticle array, wherein at least some of the nanoparticles retain exchanged replacement molecules after removal of the exchange surface.

107. A method of providing a nanoparticle array on a surface, the method comprising:
providing a body comprising an orifice formed therein, the orifice comprising an opening in an upper surface of the body;
forming an assembly surface using an aqueous solution within the orifice, wherein the assembly surface forms a gas/aqueous solution interface, wherein the assembly surface comprises a convex upwards curvature within the orifice;
depositing a colloidal suspension on the assembly surface, wherein the colloidal suspension comprises hydrophobic nanoparticles suspended in an organic solvent solution, and wherein the colloidal suspension disperses over the assembly surface; and
evaporating the organic solvent from the assembly surface, wherein the hydrophobic nanoparticles form a monolayer nanoparticle array on at least a portion of the assembly surface;
contacting the monolayer nanoparticle array with a solid surface, wherein at least a portion of the monolayer nanoparticle array in contact with the solid surface remains on the solid surface and forms at least one layer of a nanoparticle array thereon;
removing at least some organic molecules from at least some of the hydrophobic nanoparticles in the nanoparticle array on the solid surface by exposing the hydrophobic nanoparticles to an oxidizing gas;
contacting the nanoparticle array on the solid surface with replacement molecules while contacting the nanoparticle array with an exchange surface, wherein at least some of the replacement molecules exchange with at least some of the organic molecules remaining on the nanoparticles after exposing the hydrophobic nanoparticles to an oxidizing gas; and
removing the exchange surface from the nanoparticle array, wherein at least some of the nanoparticles retain exchanged replacement molecules after removal of the exchange surface.
